(19) United States
(12) Patent Application Publication
(10) Pub. No.: US 2022/0361205 A1
(43) Pub. Date: Nov. 10, 2022

(54) USER EQUIPMENTS, BASE STATIONS AND METHODS FOR CANCELLATION OF UPLINK SIGNAL(S)

(71) Applicant: SHARP KABUSHIKI KAISHA, Sakai City, Osaka (JP)

(72) Inventors: TATSUSHI AIBA, Sakai City, Osaka (JP); KAI YING, Vancouver, WA (US); KAZUNARI YOKOMAKURA, Sakai City, Osaka (JP)

(21) Appl. No.: 17/764,747

(22) PCT Filed: Sep. 25, 2020
(86) PCT No.: PCT/JP2020/036166

§ 371 Date: Mar. 29, 2022

Related U.S. Application Data
(60) Provisional application No. 62/910,152, filed on Oct. 3, 2019.

(51) Int. Cl. H04W 72/12; H04W 24/08; H04W 74/08

(52) U.S. Cl. CPC H04W 72/1268; H04W 72/1289; H04W 24/08; H04W 74/0833

(57) ABSTRACT

A user equipment (UE) is described. The UE includes receiving circuitry configured to receive a radio resource control (RRC) message comprising information used for configuring the UE to monitor a physical downlink control channel (PDCCH) for a downlink control information (DCI) format. The DCI format comprising an interruption transmission indication. The UE further includes processing circuitry configured to cancel a physical uplink shared channel (PUSCH) transmission in a physical resource block(s) and/or a symbol(s) that are indicated by the interruption transmission indication. The information is configured per uplink bandwidth part (UL BWP). The interruption transmission indication is applicable to a physical random access channel (PRACH) transmission associated with a contention based random access procedure. The interruption transmission indication is not applicable to a PRACH transmission associated with a contention free random access procedure.

### TECHNICAL FIELD

The present disclosure relates generally to communication systems. More specifically, the present disclosure relates to user equipment (UE), base stations, and methods for cancellation of uplink signal(s).

### BACKGROUND ART

Wireless communication devices have become smaller and more powerful in order to meet consumer needs and to improve portability and convenience. Consumers have become dependent upon wireless communication devices and have come to expect reliable service, expanded areas of coverage and increased functionality. A wireless communication system may provide communication for a number of wireless communication devices, each of which may be serviced by a base station. A base station may be a device that communicates with wireless communication devices.

As wireless communication devices have advanced, improvements in communication capacity, speed, flexibility and/or efficiency have been sought. However, improving communication capacity, speed, flexibility and/or efficiency may present certain problems.

For example, wireless communication devices may communicate with one or more devices using a communication structure. However, the communication structure used may only offer limited flexibility and/or efficiency. As illustrated by this discussion, systems and methods that improve communication flexibility and/or efficiency may be beneficial.

### SUMMARY OF INVENTION

In one example, a user equipment (UE) comprising: receiving circuitry configured to receive a radio resource control (RRC) message comprising information used for configuring the UE to monitor a physical downlink control channel (PDCCH) for a downlink control information (DCI) format, the DCI format comprising an interruption transmission indication, and processing circuitry configured to cancel a physical uplink shared channel (PUSCH) transmission in a physical resource block(s) and/or a symbol(s) that are indicated by the interruption transmission indication, wherein the information is configured per uplink bandwidth part (UL BWP), the interruption transmission indication is applicable to a physical random access channel (PRACH) transmission associated with a contention based random access procedure, and the interruption transmission indication is not applicable to a PRACH transmission associated with a contention free random access procedure.

In one example, a base station apparatus comprising: transmitting circuitry configured to transmit a radio resource control (RRC) message comprising information used for configuring the UE to monitor a physical downlink control channel (PDCCH) for a downlink control information (DCI) format, the DCI format comprising an interruption transmission indication, and processing circuitry configured to consider a physical uplink shared channel (PUSCH) transmission in a physical resource block(s) and/or a symbol(s) that are indicated by the interruption transmission indication is canceled, wherein the information is configured per uplink bandwidth part (UL BWP), the interruption transmission indication is applicable to a physical random access channel (PRACH) transmission associated with a contention based random access procedure, and the interruption transmission indication is not applicable to a PRACH transmission associated with a contention free random access procedure.

In one example, a communication method of a user equipment (UE) comprising: receiving a radio resource control (RRC) message comprising information used for configuring the UE to monitor a physical downlink control channel (PDCCH) for a downlink control information (DCI) format, the DCI format comprising an interruption transmission indication, and cancelling a physical uplink shared channel (PUSCH) transmission in a physical resource block(s) and/or a symbol(s) that are indicated by the interruption transmission indication, wherein the information is configured per uplink bandwidth part (UL BWP), the interruption transmission indication is applicable to a physical random access channel (PRACH) transmission associated with a contention based random access procedure, and the interruption transmission indication is not applicable to a PRACH transmission associated with a contention free random access procedure.

In one example, a communication method of a base station apparatus comprising: transmitting a radio resource control (RRC) message comprising information used for configuring the UE to monitor a physical downlink control channel (PDCCH) for a downlink control information (DCI) format, the DCI format comprising an interruption transmission indication, and considering a physical uplink shared channel (PUSCH) transmission in a physical resource block(s) and/or a symbol(s) that are indicated by the interruption transmission indication is canceled, wherein the information is configured per uplink bandwidth part (UL BWP), the interruption transmission indication is applicable to a physical random access channel (PRACH) transmission associated with a contention based random access procedure, and the interruption transmission indication is not applicable to a PRACH transmission associated with a contention free random access procedure.

### BRIEF DESCRIPTION OF DRAWINGS

FIG. 1 is a block diagram illustrating one implementation of one or more gNBs and one or more UEs in which systems and methods for signaling may be implemented.

FIG. 2 shows examples of multiple numerologies.

FIG. 3 is a diagram illustrating one example of a resource grid and resource block.

FIG. 4 shows examples of resource regions.

FIG. 5 illustrates an example of a random access procedure.

FIG. 6 illustrates various components that may be utilized in a UE.

FIG. 7 illustrates various components that may be utilized in a gNB.

FIG. 8 is a block diagram illustrating one implementation of a UE in which one or more of the systems and/or methods described herein may be implemented.

FIG. 9 is a block diagram illustrating one implementation of a gNB in which one or more of the systems and/or methods described herein may be implemented.

FIG. 10 is a block diagram illustrating one implementation of a gNB.

FIG. 11 is a block diagram illustrating one implementation of a UE.

### DESCRIPTION OF EMBODIMENTS

A user equipment (UE) is described. The UE includes receiving circuitry configured to receive a radio resource control (RRC) message comprising information used for configuring the UE to monitor a physical downlink control channel (PDCCH) for a downlink control information (DCI) format. The DCI format comprises an interruption transmission indication. The UE further includes processing circuitry configured to cancel a physical uplink shared channel (PUSCH) transmission in a physical resource block(s) and/or a symbol(s) that are indicated by the interruption transmission indication. The information is configured per uplink bandwidth part (UL BWP). The interruption transmission indication is applicable to a physical random access channel (PRACH) transmission associated with a contention based random access procedure. The interruption transmission indication is not applicable to a PRACH transmission associated with a contention free random access procedure.

A base station apparatus is described. The base station apparatus includes transmitting circuitry configured to transmit a radio resource control (RRC) message comprising information used for configuring the UE to monitor a physical downlink control channel (PDCCH) for a downlink control information (DCI) format. The DCI format comprises an interruption transmission indication. The base station apparatus further includes processing circuitry configured to consider a physical uplink shared channel (PUSCH) transmission in a physical resource block(s) and/or a symbol(s) that are indicated by the interruption transmission indication is canceled. The information is configured per uplink bandwidth part (UL BWP). The interruption transmission indication is applicable to a physical random access channel (PRACH) transmission associated with a contention based random access procedure. The interruption transmission indication is not applicable to a PRACH transmission associated with a contention free random access procedure.

A communication method of a user equipment (UE) is described. The communication method includes receiving a radio resource control (RRC) message comprising information used for configuring the UE to monitor a physical downlink control channel (PDCCH) for a downlink control information (DCI) format. The DCI format comprises an interruption transmission indication. The communication method further includes cancelling a physical uplink shared channel (PUSCH) transmission in a physical resource block(s) and/or a symbol(s) that are indicated by the interruption transmission indication. The information is configured per uplink bandwidth part (UL BWP). The interruption transmission indication is applicable to a physical random access channel (PRACH) transmission associated with a contention based random access procedure. The interruption transmission indication is not applicable to a PRACH transmission associated with a contention free random access procedure.

A communication method of a base station apparatus is described. The communication method includes transmitting a radio resource control (RRC) message comprising information used for configuring the UE to monitor a physical downlink control channel (PDCCH) for a downlink control information (DCI) format. The DCI format comprises an interruption transmission indication. The communication method further includes considering a physical uplink shared channel (PUSCH) transmission in a physical resource block(s) and/or a symbol(s) that are indicated by the interruption transmission indication is canceled. The information is configured per uplink bandwidth part (UL BWP). The interruption transmission indication is applicable to a physical random access channel (PRACH) transmission associated with a contention based random access procedure. The interruption transmission indication is not applicable to a PRACH transmission associated with a contention free random access procedure.

The 3rd Generation Partnership Project, also referred to as “3GPP,” is a collaboration agreement that aims to define globally applicable technical specifications and technical reports for third and fourth generation wireless communication systems. The 3GPP may define specifications for next generation mobile networks, systems and devices.

3GPP Long Term Evolution (LTE) is the name given to a project to improve the Universal Mobile Telecommunications System (UMTS) mobile phone or device standard to cope with future requirements. In one aspect, UMTS has been modified to provide support and specification for the Evolved Universal Terrestrial Radio Access (E-UTRA) and Evolved Universal Terrestrial Radio Access Network (E-UTRAN).

At least some aspects of the systems and methods disclosed herein may be described in relation to the 3GPP LTE, LTE-Advanced (LTE-A), 5G New Radio (5th Generation NR) and other standards (e.g., 3GPP Releases 8, 9, 10, 11, 12, 13, 14 and/or 15). However, the scope of the present disclosure should not be limited in this regard. At least some aspects of the systems and methods disclosed herein may be utilized in other types of wireless communication systems.

A wireless communication device may be an electronic device used to communicate voice and/or data to a base station, which in turn may communicate with a network of devices (e.g., public switched telephone network (PSTN), the Internet, etc.). In describing systems and methods herein, a wireless communication device may alternatively be referred to as a mobile station, a UE, an access terminal, a subscriber station, a mobile terminal, a remote station, a user terminal, a terminal, a subscriber unit, a mobile device, etc. Examples of wireless communication devices include cellular phones, smart phones, personal digital assistants (PDAs), laptop computers, netbooks, e-readers, wireless modems, etc. In 3GPP specifications, a wireless communication device is typically referred to as a UE. However, as the scope of the present disclosure should not be limited to the 3GPP standards, the terms “UE” and “wireless communication device” may be used interchangeably herein to mean the more general term “wireless communication device.” A UE may also be more generally referred to as a terminal device.

In 3GPP specifications, a base station is typically referred to as a Node B, an evolved Node B (eNB), a gNB, a home enhanced or evolved Node B (HeNB) or some other similar terminology. As the scope of the disclosure should not be limited to 3GPP standards, the terms “base station,” “Node B,” “eNB,” “gNB” and “HeNB” may be used interchangeably herein to mean the more general term “base station.” Furthermore, the term “base station” may be used to denote an access point. An access point may be an electronic device that provides access to a network (e.g., Local Area Network (LAN), the Internet, etc.) for wireless communication devices. The term “communication device” may be used to denote both a wireless communication device and/or a base station. An eNB may also be more generally referred to as a base station device.

It should be noted that as used herein, a “cell (e.g., serving cell)” may be any communication channel that is specified by standardization or regulatory bodies to be used for International Mobile Telecommunications-Advanced (IMT-Advanced) and all of it or a subset of it may be adopted by 3GPP as licensed bands (e.g., frequency bands) to be used for communication between an eNB and a UE. It should also be noted that in E-UTRA and E-UTRAN overall description, as used herein, a “cell (e.g., serving cell)” may be defined as “combination of downlink and optionally uplink resources.” The linking between the carrier frequency of the downlink resources and the carrier frequency of the uplink resources may be indicated in the system information transmitted on the downlink resources.

The 5th generation communication systems, dubbed NR (New Radio technologies) by 3GPP, envision the use of time/frequency/space resources to allow for services, such as eMBB (enhanced Mobile Broad-Band) transmission, URLLC (Ultra Reliable and Low Latency Communication) transmission, and eMTC (massive Machine Type Communication) transmission. And, in NR, transmissions for different services may be specified (e.g., configured) for one or more bandwidth parts (BWPs) in a serving cell and/or for one or more serving cells. A user equipment (UE) may perform a reception(s) of a downlink signal(s) and/or a transmission(s) of an uplink signal(s) in the BWP(s) of the serving cell(s).

In order for the services to use the time, frequency, and/or space resources efficiently, it would be useful to be able to efficiently control downlink and/or uplink transmissions. Therefore, a procedure for efficient control of downlink and/or uplink transmissions should be designed. Accordingly, a detailed design of a procedure for downlink and/or uplink transmissions may be beneficial.

Various examples of the systems and methods disclosed herein are now described with reference to the Figures, where like reference numbers may indicate functionally similar elements. The systems and methods as generally described and illustrated in the Figures herein could be arranged and designed in a wide variety of different implementations. Thus, the following more detailed description of several implementations, as represented in the Figures, is not intended to limit scope, as claimed, but is merely representative of the systems and methods.

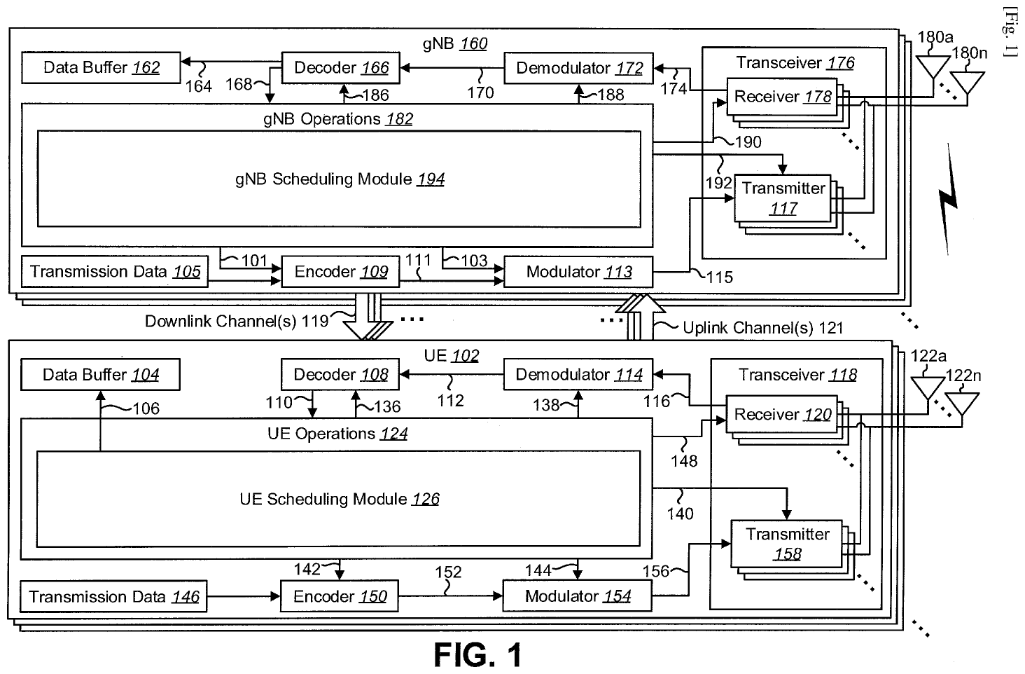

FIG. 1 is a block diagram illustrating one implementation of one or more gNBs 160 and one or more UEs 102 in which systems and methods for signaling may be implemented. The one or more UEs 102 communicate with one or more gNBs 160 using one or more physical antennas 122a-n. For example, a UE 102 transmits electromagnetic signals to the gNB 160 and receives electromagnetic signals from the gNB 160 using the one or more physical antennas 122a-n. The gNB 160 communicates with the UE 102 using one or more physical antennas 180a-n. In some implementations, the term “base station,” “eNB,” and/or “gNB” may refer to and/or may be replaced by the term “Transmission Reception Point (TRP).” For example, the gNB 160 described in connection with FIG. 1 may be a TRP in some implementations.

The UE 102 and the gNB 160 may use one or more channels and/or one or more signals 119, 121 to communicate with each other. For example, the UE 102 may transmit information or data to the gNB 160 using one or more uplink channels 121. Examples of uplink channels 121 include a physical shared channel (e.g., PUSCH (physical uplink shared channel)) and/or a physical control channel (e.g., PUCCH (physical uplink control channel)), etc. The one or more gNBs 160 may also transmit information or data to the one or more UEs 102 using one or more downlink channels 119, for instance. Examples of downlink channels 119 include a physical shared channel (e.g., PDCCH (physical downlink shared channel) and/or a physical control channel (PDCCH (physical downlink control channel)), etc. Other kinds of channels and/or signals may be used.

Each of the one or more UEs 102 may include one or more transceivers 118, one or more demodulators 114, one or more decoders 108, one or more encoders 150, one or more modulators 154, a data buffer 104 and a UE operations module 124. For example, one or more reception and/or transmission paths may be implemented in the UE 102. For convenience, only a single transceiver 118, decoder 108, demodulator 114, encoder 150 and modulator 154 are illustrated in the UE 102, though multiple parallel elements (e.g., transceivers 118, decoders 108, demodulators 114, encoders 150 and modulators 154) may be implemented.

The transceiver 118 may include one or more receivers 120 and one or more transmitters 158. The one or more receivers 120 may receive signals from the gNB 160 using one or more antennas 122a-n. For example, the receiver 120 may receive and downconvert signals to produce one or more received signals 116. The one or more received signals 116 may be provided to a demodulator 114. The one or more transmitters 158 may transmit signals to the gNB 160 using one or more physical antennas 122a-n. For example, the one or more transmitters 158 may upconvert and transmit one or more modulated signals 156.

The demodulator 114 may demodulate the one or more received signals 116 to produce one or more demodulated signals 112. The one or more demodulated signals 112 may be provided to the decoder 108. The UE 102 may use the decoder 108 to decode signals. The decoder 108 may produce decoded signals 110, which may include a UE-decoded signal 106 (also referred to as a first UE-decoded signal 106). For example, the first UE-decoded signal 106 may comprise received payload data, which may be stored in a data buffer 104. Another signal included in the decoded signals 110 (also referred to as a second UE-decoded signal 110) may comprise overhead data and/or control data. For example, the second UE-decoded signal 110 may provide data that may be used by the UE operations module 124 to perform one or more operations.

In general, the UE operations module 124 may enable the UE 102 to communicate with the one or more gNBs 160. The UE operations module 124 may include one or more of a UE scheduling module 126.

The UE scheduling module 126 may perform downlink reception(s) and uplink transmission(s). The downlink reception(s) include reception of data, reception of downlink control information, and/or reception of downlink reference signals. Also, the uplink transmissions include transmission of data, transmission of uplink control information, and/or transmission of uplink reference signals.

In a radio communication system, physical channels (uplink physical channels and/or downlink physical channels) may be defined. The physical channels (uplink physical channels and/or downlink physical channels) may be used for transmitting information that is delivered from a higher layer.

For example, in uplink, a PRACH (Physical Random Access Channel) may be defined. In some approaches, the PRACH (e.g., the random access procedure) may be used for an initial access connection establishment procedure, a handover procedure, a connection re-establishment, a timing adjustment (e.g., a synchronization for an uplink transmission, for UL synchronization) and/or for requesting an uplink shared channel (UL-SCH) resource (e.g., the uplink physical shared channel (PSCH) (e.g., PUSCH) resource).

In another example, a physical uplink control channel (PUCCH) may be defined. The PUCCH may be used for transmitting uplink control information (UCI). The UCI may include hybrid automatic repeat request-acknowledgement (HARQ-ACK), channel state information (CSI) and/or a scheduling request (SR). The HARQ-ACK is used for indicating a positive acknowledgement (ACK) or a negative acknowledgment (NACK) for downlink data (e.g., Transport block(s), Medium Access Control Protocol Data Unit (MAC PDU) and/or Downlink Shared Channel (DL-SCH)). The CSI is used for indicating state of downlink channel (e.g., a downlink signal(s)). The CSI may include aperiodic CSI (e.g., transmitted on the PUSCH), semi-persistent CSI (e.g., transmitted on the PUSCH and/or the PUCCH), and/or periodic CSI (e.g., transmitted on the PUSCH and/or the PUCCH). Also, the SR is used for requesting resources of uplink data (e.g., Transport block(s), MAC PDU and/or Uplink Shared Channel (UL-SCH)).

Here, the DL-SCH and/or the UL-SCH may be a transport channel that is used in the MAC layer. For example, the DL-SCH may be mapped to the PDSCH. Also, the UL-SCH may be mapped the PUSCH. Also, a transport block(s) (TB(s)) and/or a MAC PDU may be defined as a unit(s) of the transport channel used in the MAC layer. The transport block may be defined as a unit of data delivered from the MAC layer to the physical layer. The MAC layer may deliver the transport block to the physical layer (e.g., the MAC layer delivers the data as the transport block to the physical layer). In the physical layer, the transport block may be mapped to one or more codewords.

In downlink, a physical downlink control channel (PDCCH) may be defined. The PDCCH may be used for transmitting downlink control information (DCI). Here, more than one DCI formats may be defined for DCI transmission on the PDCCH. Namely, fields may be defined in the DCI format(s), and the fields are mapped to the information bits (e.g., DCI bits).

For example, a DCI format 1_0 that is used for scheduling of the PDSCH in the cell may be defined as the DCI format for the downlink. Also, as described herein one or more Radio Network Temporary Identifiers (e.g., the Cell RNTI(s) (C-RNTI(s)), the Configured Scheduling RNTI(s) (CS-RNTI(s)), the System Information RNTI(s) (SI-RNTI(s)), the Random Access RNTI(s) (RA-RNTI(s)), the MCS-C-RNTI (Modulation and Coding Scheme-C-RNTI), and/or a first RNTI may be used to transmit the DCI format 1_O. Also, the DCI format 1_0 may be monitored (e.g., transmitted, mapped) in the Common Search Space (CSS) and/or the UE Specific Search space (USS). Alternatively, the DCI format 1_0 may be monitored (e.g., transmitted, mapped) in the CSS only.

For example, the DCI included in the DCI format 1_0 may be a frequency domain resource assignment (e.g., for the PDSCH). Additionally or alternatively, the DCI included in the DCI format 1_0 may be a time domain resource assignment (e.g., for the PDSCH). Additionally or alternatively, the DCI included in the DCI format 1_0 may be a modulation and coding scheme (e.g., for the PDSCH). Additionally or alternatively, or alternatively, the DCI included in the DCI format 1_0 may be a new data indicator. Additionally or alternatively, the DCI included in the DCI format 1_0 may be a TPC (e.g., Transmission Power Control) command for scheduled PUCCH. Additionally or alternatively, the DCI included in the DCI format 1_0 may be a PUCCH resource indicator. Additionally or alternatively, the DCI included in the DCI format 1_0 may be a PDSCH-to-HARQ feedback timing indicator. Additionally or alternatively, the DCI included in the DCI format 1_0 may be a priority indicator.

Additionally or alternatively, a DCI format 1_1 that is used for scheduling of the PDSCH in the cell may be defined as the DCI format for the downlink. Additionally or alternatively, the C-RNTI, the CS-RNTI, the MCS-C-RNTI, and/or the first RNTI may be used to transmit the DCI format 1_1. Additionally or alternatively, the DCI format 1_1 may be monitored (e.g., transmitted and/or mapped) in the CSS and/or the USS.

For example, the DCI included in the DCI format 1_1 may be a BWP indicator (e.g., for the PDSCH). Additionally or alternatively, the DCI included in the DCI format 1_1 may be frequency domain resource assignment (e.g., for the PDSCH). Additionally or alternatively, the DCI included in the DCI format 1_1 may be a time domain resource assignment (e.g., for the PDSCH). Additionally or alternatively, the DCI included in the DCI format 1_1 may be a modulation and coding scheme (e.g., for the PDSCH). Additionally or alternatively, the DCI included in the DCI format 1_1 may be a new data indicator. Additionally or alternatively, the DCI included in the DCI format 1_1 may be a TPC command for scheduled PUCCH. Additionally or alternatively, the DCI included in the DCI format 1_1 may be a CSI request that is used for requesting (e.g., triggering) transmission of the CSI (e.g., CSI reporting (e.g., aperiodic CSI reporting)). Additionally or alternatively, the DCI included in the DCI format 1_1 may be a PUCCH resource indicator. Additionally or alternatively, the DCI included in the DCI format 1_1 may be a PDSCH-to-HARQ feedback timing indicator. Additionally or alternatively, the DCI included in the DCI format 1_1 may be a priority indicator.

Additionally or alternatively, a DCI format 0_0 that is used for scheduling of the PUSCH in the cell may be defined as the DCI format for the uplink. Additionally or alternatively, the C-RNTI, the CS-RNTI, the Temporary C-RNTI, the MCS-C-RNTI and/or the first RNTI may be used to transmit the DCI format 0_0. Additionally or alternatively, the DCI format 0_0 may be monitored (e.g., transmitted, mapped) in the CSS and/or the USS. Alternatively, the DCI format 0_0 may be monitored (e.g., transmitted, mapped) in the CSS only.

For example, the DCI included in the DCI format 0_0 may be a frequency domain resource assignment (e.g., for the PUSCH). Additionally or alternatively, the DCI included in the DCI format 0_0 may be a time domain resource assignment (e.g., for the PUSCH). Additionally or alternatively, the DCI included in the DCI format 0_0 may be a modulation and coding scheme (e.g., for the PUSCH). Additionally or alternatively, the DCI included in the DCI format 0_0 may be a new data indicator. Additionally or alternatively, the DCI included in the DCI format 0_0 may be a redundancy version. Additionally or alternatively, the DCI included in the DCI format 0_0 may be a TPC command for scheduled PUSCH. Additionally or alternatively, the DCI included in the DCI format 0_0 may be a priority indicator.

Additionally or alternatively, a DCI format 0_1 that is used for scheduling of the PUSCH in the cell may be defined as the DCI format for the uplink. Here, the DCI format 0_1 may be described as a first DCI format 601. Additionally or alternatively, the C-RNTI, the CS-RNTI, and/or the MCS-C-RNTI may be used to transmit the DCI format 0_1 (i.e., the first DCI format 601). Namely, the first DCI format 601 may be the DCI format 0_1 with the CRC scrambled by the C-RNTI, the CS-RNTI, and/or the MCS-C-RNTI. Here, as described below, the DCI format 0_1 with the CRC scrambled by the MCS-C-RNTI and/or the first RNTI may be a second DCI format 603. Additionally or alternatively, the DCI format 0_1 (i.e., the first DCI format 601) may be monitored (e.g., transmitted, mapped) in the CSS and/or the USS.

For example, the DCI included in the DCI format 0_1 may be a BWP indicator (e.g., for the PUSCH). Additionally or alternatively, the DCI included in the DCI format 0_1 may be a frequency domain resource assignment (e.g., for the PUSCH). Additionally or alternatively, the DCI included in the DCI format 0_1 may be a time domain resource assignment (e.g., for the PUSCH). Additionally or alternatively, the DCI included in the DCI format 0_1 may be a modulation and coding scheme (e.g., for the PUSCH). Additionally or alternatively, the DCI included in the DCI format 0_1 may be a new data indicator. Additionally or alternatively, the DCI included in the DCI format 0_1 may be a TPC command for scheduled PUSCH. Additionally or alternatively, the DCI included in the DCI format 0_1 may be a CSI request that is used for requesting the CSI reporting. Additionally or alternatively, the DCI included in the DCI format 0_1 may be a priority indicator.

Here, the PUSCH transmission scheduled by using the PDCCH (e.g., the DCI format 0_0 and/or the DCI format 0_1) with the CRC scrambled by the C-RNTI, the CS-RNTI, and/or the MCS-C-RNTI described herein may be assumed to be included in a first PUSCH transmission in some implementations for the sake of simplifying descriptions.

Additionally or alternatively, a DCI format 2_1 that is used for notifying a PRB(s) and/or a symbol(s) (e.g., OFDM symbol(s) and/or SC-FDMA symbol(s)) where the UE 102 assumes that no transmission (e.g., from the gNB 160 to the UE 102 (i.e., in the downlink)) is intended for the UE may be defined as the DCI format (e.g., as the DCI format for other purposes). Additionally or alternatively, the DCI format 2_1 may be used for notifying the PRB(s) and/or the symbol(s) where no transmission (e.g., from the UE 102 to the gNB 160 (i.e., in the uplink)) is performed from the UE.

Additionally or alternatively, an interruption RNTI (e.g., INT-RNTI) and/or the first RNTI may be used to transmit the DCI format 2_1. Additionally or alternatively, the DCI format 2_1 may be monitored (e.g., transmitted and/or mapped) in the CSS. For example, in a case that the INT-RNTI is used to transmit the DCI format 2_1 (e.g., in a case that the CRC attached to the DCI format 2_1 is scrambled by the INT-RNTI), the DCI format 2_1 may be used for notifying a PRB(s) and/or a symbol(s) where the UE 102 assumes that no transmission is intend for the UE. Additionally or alternatively, in a case that the first RNTI is used to transmit the DCI format 2_1 (e.g., in a case that the CRC attached to the DCI format 2_1 is scrambled by the first RNTI), the DCI format 2_1 may be used for notifying the PRB(s) and/or the symbol(s) where no transmission is performed from the UE.

For example, the DCI included in the DCI format 2_1 (e.g., with the CRC scrambled by the INT-RNTI) may be an indication 1 (e.g., a pre-emption indication 1), an indication 2 (e.g., a pre-emption indication 2), . . . an indication N (e.g., a pre-emption indication N) (e.g., N=14). Namely, the DCI included in the DCI format 2_1 (e.g., with the CRC scrambled by the INT-RNTI) may be 14 bits. For example, a bit value “0” of the DCI included in the DCI format 2_1 (e.g., with the CRC scrambled by the INT-RNTI) may be used for indicating a transmission(s) (e.g., in the downlink (e.g., on the PDSCH)) to the UE 102 in a corresponding PRB(s) and/or symbol(s) (e.g., a set of PRB(s) and/or a set of symbol(s)). Additionally or alternatively, a bit value “1” of the DCI included in the DCI format 2_1 (e.g., with the CRC scrambled by the INT-RNTI) may be used for indicating no transmission(s) (e.g., in the downlink (e.g., on the PDSCH)) to the UE 102 in the corresponding PRB(s) and/or symbol(s). Here, information used for configuring (e.g., determining) the corresponding PRB(s) and/or symbol(s) may be configured by using the RRC message. Namely, the gNB 160 may transmit, by using the RRC message, information used for configuring (e.g., determining) the PRB(s) and/or the symbol(s) for the transmission(s) and/or no transmission(s) (e.g., in the downlink). And, the UE 102 may determine the corresponding PRB(s) and symbol(s) for the transmission(s) and/or no transmission(s) (e.g., in the downlink).

Additionally or alternatively, a DCI format 2_X may be used for notifying the PRB(s) and/or the symbol(s) where no transmission (e.g., from the UE 102 to the gNB 160 (i.e., in the uplink)) is performed from the UE. Additionally or alternatively, the C-RNTI, the INT-RNTI and/or the first RNTI may be used to transmit the DCI format 2_X. Additionally or alternatively, the DCI format 2_X may be monitored (e.g., transmitted and/or mapped) in the USS and/or the CSS.

Here, the DCI format 2_1 (e.g., with the CRC scrambled by the first RNTI) and/or the DCI format 2_X (e.g., with the CRC scrambled by the C-RNTI, the INT-RNTI, and/or the first RNTI) described herein may be assumed to be included in a DCI format 2_Y in some implementations for the sake of simple descriptions. Namely, the DCI format 2_Y may be used for notifying the PRB(s) and/or the symbol(s) where no transmission (e.g., the UL signal(s) transmission from the UE 102 to the gNB 160 in the uplink)) is performed from the UE. Additionally or alternatively, the DCI format 2_Y may be monitored (e.g., transmitted and/or mapped) in the USS and/or the CSS.

Additionally or alternatively, the DCI format Y may be used for notifying the PRB(s) and/or the symbol(s) where the UE 102 is not allowed (e.g., is not granted) to perform the UL signal(s) transmission. Additionally or alternatively, the DCI format 2_1 may be used for notifying the PRB(s) and/or the symbol(s) where the UE 102 cancels the UL signal(s) transmission (e.g., stop performing the UL signal(s) transmission). For example, (e.g., in a case that the UE 102 is scheduled (e.g., is granted) to perform the UL signal(s) transmission), the DCI format 2_1 may be used for notifying the PRB(s) and/or the symbol(s) where the UE 102 cancel the corresponding (i.e., scheduled) UL signal(s) transmission (e.g., stop performing the corresponding UL signal(s) transmission). For example, in a case that a PBR(s) and/or a symbol(s) (e.g., is scheduled for the UL signal(s) transmission) overlaps with a certain PRB(s) and/or a certain symbol(s), the UE 102 may cancel the UL signal(s) transmission (e.g., stop performing the UL signal(s) transmission, performing no UL signal(s) transmission) in the certain PRB(s) and/or the certain symbol(s).

For example, the DCI included in the DCI format 2_Y may be an indication 1 (e.g., a pre-emption indication 1), an indication 2 (e.g., a pre-emption indication 2), . . . an indication N (e.g., a pre-emption indication N) (e.g., N=14). Namely, the DCI included in the DCI format Y may be 14 bits. For example, a bit value “0” of the DCI included in the DCI format 2_Y may be used for indicating a transmission(s) (e.g., in the uplink) from the UE 102 in a corresponding PRB(s) and/or symbol(s) (e.g., a set of PRB(s) and/or a set of symbol(s)). Additionally or alternatively, a bit value “1” of the DCI included in the DCI format 2_Y may be used for indicating no transmission(s) (e.g., in the uplink) from the UE 102 in the corresponding PRB(s) and/or symbol(s). Here, information used for configuring (e.g., determining) the corresponding PRB(s) and/or symbol(s) may be configured by using the RRC message. Namely, the gNB 160 may transmit, by using the RRC message, information used for configuring (e.g., determining) the PRB(s) and/or the symbol(s) for the transmission(s) and/or no transmission(s) (e.g., in the uplink). And, the UE 102 may determine the corresponding PRB(s) and symbol(s) for the transmission(s) and/or no transmission(s) (e.g., in the uplink).

Here, as described above, a RNTI(s) (e.g., a Radio Network Temporary Identifier(s)) assigned to the UE 102 may be used for transmission of DCI (e.g., the DCI format(s), DL control channel(s) (e.g., the PDCCH(s)). Namely, the gNB 160 may transmit, (e.g., by using the RRC message), information used for configuring (e.g., assigning) the RNTI(s) to the UE 102.

For example, CRC (Cyclic Redundancy Check) parity bits (also referred to simply as CRC), which are generated based on DCI, are attached to DCI, and, after attachment, the CRC parity bits are scrambled by the RNTI(s). The UE 102 may attempt to decode (e.g., blind decoding, monitor, detect) DCI to which the CRC parity bits scrambled by the RNTI(s) are attached. For example, the UE 102 detects DL control channel (e.g., the PDCCH, the DCI, the DCI format(s)) based on the blind decoding. That is, the UE 102 may decode the DL control channel(s) with the CRC scrambled by the RNTI(s). In other words, the UE 102 may monitor the DL control channel(s) with the RNTI(s). For example, the UE 102 may detect the DCI format(s) with the RNTI(s).

Here, the RNTI(s) may include the C-RNTI(s) (Cell-RNTI(s)), the CS-RNTI(s) (Configured Scheduling C-RNTI(s)), the SI-RNTI(s) (System Information RNTI(s)), the RA-RNTI(s) (Random Access-RNTI(s)), the Temporary C-RNTI(s), the MCS-C-RNTI (Modulation and Coding Scheme-C-RNTI), the INT-RNTI (Interruption RNTI), and/or the first RNTI.

For example, the C-RNTI(s) may be an unique identification used for identifying an RRC connection and/or scheduling. Additionally or alternatively, the CS-RNTI(s) may be an unique identification used for scheduling of transmission based on a configured grant. Additionally or alternatively, the SI-RNTI may be used for identifying system information (SI) (e.g., an SI message) mapped on the BCCH and dynamically carried on DL-SCH. Additionally or alternatively, the SI-RNTI may be used for broadcasting of SI. Additionally or alternatively, the RA-RNTI may be an identification used for the random access procedure (e.g., Msg.2 transmission). Additionally or alternatively, the Temporary C-RNTI may be used for the random access procedure (e.g., scheduling of Msg.3 (re)transmission (e.g., Msg.3 PUSCH (re)transmission)). Additionally or alternatively, the MCS-C-RNTI may be an unique identification used for indicating a MCS table (e.g., an alternative MCS table) for the PDSCH and/or the PUSCH. Additionally or alternatively, the INT-RNTI may be an identification of pre-emption in the downlink. Additionally or alternatively, the INT-RNTI may be an identification of pre-emption in the uplink. The first RNTI may be different from the C-RNTI, the CS-RNTI, the SI-RNTI, the RA-RNTI, the Temporary C-RNTI, the MCS-C-RNTI, and/or the INT-RNTI. Additionally or alternatively, the first RNTI may be an identification for pre-emption in the uplink.

Additionally or alternatively, a physical downlink shared channel (PDSCH) and a physical uplink shared channel (PUSCH) may be defined. For example, in a case that the PDSCH (e.g., the PDSCH resource) is scheduled by using the DCI format(s) for the downlink, the UE 102 may receive the downlink data, on the scheduled PDSCH (e.g., the PDSCH resource). Additionally or alternatively, in a case that the PUSCH (e.g., the PUSCH resource) is scheduled by using the DCI format(s) for the uplink, the UE 102 transmits the uplink data, on the scheduled PUSCH (e.g., the PUSCH resource). For example, the PDSCH may be used to transmit the downlink data (e.g., DL-SCH(s), a downlink transport block(s)). Additionally or alternatively, the PUSCH may be used to transmit the uplink data (e.g., the UL-SCH(s), the uplink transport block(s), the MAC PDU).

Furthermore, the PDSCH and/or the PUSCH may be used to transmit information of a higher layer (e.g., a radio resource control (RRC)) layer, and/or a MAC layer). For example, the PDSCH (e.g., from the gNB 160 to the UE 102) and/or the PUSCH (e.g., from the UE 102 to the gNB 160) may be used to transmit a RRC message (a RRC signal). Additionally or alternatively, the PDSCH (e.g., from the gNB 160 to the UE 102) and/or the PUSCH (e.g., from the UE 102 to the gNB 160) may be used to transmit a MAC control element (a MAC CE). Here, the RRC message and/or the MAC CE are also referred to as a higher layer signal.

In some approaches, a physical broadcast channel (PBCH) may be defined. For example, the PBCH may be used for broadcasting the MIB (master information block).

Here, system information may be divided into the MIB and a number of SIB(s) (system information block(s)). For example, the MIB may be used for carrying include minimum system information. Additionally or alternatively, the SIB(s) may be used for carrying system information messages.

In some approaches, in downlink, a SS (Synchronization Signal) may be defined. The SS may be used for acquiring time and/or frequency synchronization with a cell. The SS may include a PSS (Primary Synchronization Signal). Additionally or alternatively, the SS may include a SSS (Secondary Synchronization Signal). For example, the PSS, the SSS, and/or the PBCH may be used for identifying a physical layer cell identity. Additionally or alternatively, the PSS, the SSS, and/or the PBCH may be used for carrying information identifying SF number (System Frame number), an OFDM symbol index, a slot index in a radio frame and/or a radio frame number. Additionally or alternatively, the PSS, the SSS, the PBCH, and a demodulation reference signal (e.g., DM RS) for the PBCH may form a block of the SS and/or the PBCH (e.g., the SS/PBCH block). For example, in a time domain, the SS/PBCH block may have 4 OFDM symbols. The UE 102 may assume that a reception occasion(s) of the SS/PBCH block(s) may be in consecutive symbol(s).

In the radio communication for uplink, an uplink reference signal(s) (e.g., UL RS(s)) may be defined as uplink physical signal(s). For example, the UL RS(s) may include a demodulation reference signal(s) (e.g., a demodulation reference signal associated with the PUSCH and/or a demodulation reference signal associated with the PUSCH). For example, the demodulation reference signal associated with the PUSCH may be transmitted with the PUSCH (e.g., a scheduled PUSCH). Also, the demodulation reference signal associated with the PUCCH may be transmitted with the PUCCH. Additionally or alternatively, UL RS(s) may include a sounding reference signal(s) (e.g., the SRS(s)). Additionally or alternatively, in the radio communication for downlink, DL RS(s) may be used as downlink physical signal(s). The uplink physical signal(s) and/or the downlink physical signal(s) may not be used to transmit information that is provided from the higher layer, but is used by a physical layer.

Here, the downlink physical channel(s) and/or the downlink physical signal(s) described herein may be assumed to be included in a downlink signal (e.g., a DL signal(s)) in some implementations for the sake of simple descriptions. Additionally or alternatively, the uplink physical channel(s) and/or the uplink physical signal(s) described herein may be assumed to be included in an uplink signal (i.e. an UL signal(s)) in some implementations for the sake of simple descriptions.

Also, in a carrier aggregation (CA), the gNB 160 and the UE 102 may communicate with each other using one or more serving cells. Here the one or more serving cells may include one primary cell and one or more secondary cells. For example, the gNB 160 may transmit, by using the RRC message, information used for configuring one or more secondary cells to form together with the primary cell a set of serving cells. Namely, the set of serving cells may include one primary cell and one or more secondary cells. Here, the primary cell may be always activated. Also, the gNB 160 may activate one or more secondary cell within the configured secondary cells. Here, in the downlink, a carrier corresponding to the primary cell may be the downlink primary component carrier (i.e., the DL PCC), and a carrier corresponding to a secondary cell may be the downlink secondary component carrier (i.e., the DL SCC). Also, in the uplink, a carrier corresponding to the primary cell may be the uplink primary component carrier (i.e., the UL PCC), and a carrier corresponding to the secondary cell may be the uplink secondary component carrier (i.e., the UL SCC).

Additionally or alternatively, a dual connectivity operation may be supported. For example, in the dual connectivity operation, a special cell may be defined. For example, the special cell may include the primary cell (e.g., the primary cell of a master cell group (e.g., a MSG)) and/or a primary secondary cell (e.g., the primary secondary cell of a secondary cell group (e.g., a SCG)). Here, the primary secondary cell may be referred to as a primary secondary cell group cell (e.g., a Primary SCG cell). Namely, the term “the special cell” refers to the primary cell (e.g., the primary cell of the MCG) and/or the primary secondary cell (e.g., the primary secondary cell of the SCG).

For example, the primary cell may be a serving cell (e.g., the MCG cell), operating a primary frequency, in which the UE 102 may perform an initial connection establishment procedure and/or initiate a connection re-establishment procedure. Also, the primary secondary cell may be a serving cell (e.g., the SCG cell) in which the UE 102 may perform the random access procedure (e.g., in a case that the UE 102 perform a reconfiguration (e.g., a reconfiguration with a synchronization procedure)).

Additionally or alternatively, the special cell may be always activated (e.g., the special cell may not be deactivated). Namely, the secondary cell(s) may be activated and deactivated. Also, a transmission(s) of the PUCCH may be performed (e.g., supported) only on the special cell. Namely, the transmission(s) of the PUCCH may be always performed on the special cell. For example, resources (e.g., a resource set(s)) for the transmission of the PUCCH may be configured and/or indicated (e.g., for the UE 102 by the gNB 160 (e.g., by using the RRC message and/or the DCI format(s))) only on the special cell. Additionally or alternately, resources (e.g., a resource set(s)) for the transmission of the PUCCH may be configured and/or indicated (e.g., for the UE 102 by the gNB 160 (e.g., by using the RRC message and/or the DCI format(s))) only on each UL BWP of the special cell (e.g., only on each UL BWP in a set of UL BWPs of the special cell). Additionally or alternatively, the contention based random access procedure may be performed (e.g., supported) only on the special cell.

Namely, the serving cell(s) may include the primary cell(s) (e.g., the primary cell of the MCG), the primary secondary cell(s) (e.g., the primary secondary cell of the SCG), and/or the secondary cell(s) (e.g., the secondary cell(s) of the MCG and/or the SCG).

For example, the gNB 160 may transmit, by using the RRC message, information used for configuring an index of the serving cell(s) (e.g., an index of the primary secondary cell(s) and/or an index of the secondary cell(s)). Namely, the index of the serving cell(s) may be used for identifying the serving cell(s). The UE 102 may identify the serving cell(s) based on the index of the serving cell(s). Here, an index of the primary cell may be defined as “0”. Namely, the index of the primary cell may be always “0”. For example, the gNB 160 may transmit, by using the RRC message, information used for configuring an index of the secondary cell(s). And, the UE 102 may identify the index of the serving cell(s) (e.g., the secondary cell(s)), based on the information.

Additionally or alternatively, the gNB 160 may transmit, by using the RRC message, information used for configuring a cell group(s) (e.g., a cell group(s) associated with the dual connectivity operation (e.g., the MCG(s) and/or the SCG(s))). As described above, the MCG may include the primary cell and/or the secondary cell(s). Also, the SCG may include the primary secondary cell and/or the secondary cell(s). For example, in the dual connectivity operation, in a case that the UE 102 is configured the cell group(s) (e.g., the MCG(s) and/or the SCG(s)), the UE 102 is configured with two MAC entities (e.g., one MAC entity for the MCG and one MAC entity for SCG). For example, in a case that the UE 102 is not configured the cell group(s) (e.g., the MCG(s) and/or the SCG(s)), the UE 102 is configured with one MAC entities (e.g., one MAC entity for the MCG). Namely, for Dual Connectivity operation, the term “the special cell” may refer to the primary cell of the MCG or the primary secondary cell of the SCG depending on if the MAC entity is associated to the MCG or the SCG, respectively.

The UE operations module 124 may provide information 148 to the one or more receivers 120. For example, the UE operations module 124 may inform the receiver(s) 120 when to receive retransmissions.

The UE operations module 124 may provide information 138 to the demodulator 114. For example, the UE operations module 124 may inform the demodulator 114 of a modulation pattern anticipated for transmissions from the gNB 160.

The UE operations module 124 may provide information 136 to the decoder 108. For example, the UE operations module 124 may inform the decoder 108 of an anticipated encoding for transmissions from the gNB 160.

The UE operations module 124 may provide information 142 to the encoder 150. The information 142 may include data to be encoded and/or instructions for encoding. For example, the UE operations module 124 may instruct the encoder 150 to encode transmission data 146 and/or other information 142. The other information 142 may include PDSCH HARQ-ACK information.

The encoder 150 may encode transmission data 146 and/or other information 142 provided by the UE operations module 124. For example, encoding the data 146 and/or other information 142 may involve error detection and/or correction coding, mapping data to space, time and/or frequency resources for transmission, multiplexing, etc. The encoder 150 may provide encoded data 152 to the modulator 154.

The UE operations module 124 may provide information 144 to the modulator 154. For example, the UE operations module 124 may inform the modulator 154 of a modulation type (e.g., constellation mapping) to be used for transmissions to the gNB 160. The modulator 154 may modulate the encoded data 152 to provide one or more modulated signals 156 to the one or more transmitters 158.

The UE operations module 124 may provide information 140 to the one or more transmitters 158. This information 140 may include instructions for the one or more transmitters 158. For example, the UE operations module 124 may instruct the one or more transmitters 158 when to transmit a signal to the gNB 160. For instance, the one or more transmitters 158 may transmit during a UL subframe. The one or more transmitters 158 may upconvert and transmit the modulated signal(s) 156 to one or more gNBs 160.

Each of the one or more gNBs 160 may include one or more transceivers 176, one or more demodulators 172, one or more decoders 166, one or more encoders 109, one or more modulators 113, a data buffer 162 and a gNB operations module 182. For example, one or more reception and/or transmission paths may be implemented in a gNB 160. For convenience, only a single transceiver 176, decoder 166, demodulator 172, encoder 109 and modulator 113 are illustrated in the gNB 160, though multiple parallel elements (e.g., transceivers 176, decoders 166, demodulators 172, encoders 109 and modulators 113) may be implemented.

The transceiver 176 may include one or more receivers 178 and one or more transmitters 117. The one or more receivers 178 may receive signals from the UE 102 using one or more physical antennas 180a-n. For example, the receiver 178 may receive and downconvert signals to produce one or more received signals 174. The one or more received signals 174 may be provided to a demodulator 172. The one or more transmitters 117 may transmit signals to the UE 102 using one or more physical antennas 180a-n. For example, the one or more transmitters 117 may upconvert and transmit one or more modulated signals 115.

The demodulator 172 may demodulate the one or more received signals 174 to produce one or more demodulated signals 170. The one or more demodulated signals 170 may be provided to the decoder 166. The gNB 160 may use the decoder 166 to decode signals. The decoder 166 may produce one or more decoded signals 164, 168. For example, a first eNB-decoded signal 164 may comprise received payload data, which may be stored in a data buffer 162. A second eNB-decoded signal 168 may comprise overhead data and/or control data. For example, the second eNB-decoded signal 168 may provide data (e.g., PDSCH HARQ-ACK information) that may be used by the gNB operations module 182 to perform one or more operations.

In general, the gNB operations module 182 may enable the gNB 160 to communicate with the one or more UEs 102. The gNB operations module 182 may include one or more of a gNB scheduling module 194. The gNB scheduling module 194 may perform scheduling of downlink and/or uplink transmissions as described herein.

The gNB operations module 182 may provide information 188 to the demodulator 172. For example, the gNB operations module 182 may inform the demodulator 172 of a modulation pattern anticipated for transmissions from the UE(s) 102.

The gNB operations module 182 may provide information 186 to the decoder 166. For example, the gNB operations module 182 may inform the decoder 166 of an anticipated encoding for transmissions from the UE(s) 102.

The gNB operations module 182 may provide information 101 to the encoder 109. The information 101 may include data to be encoded and/or instructions for encoding. For example, the gNB operations module 182 may instruct the encoder 109 to encode information 101, including transmission data 105.

The encoder 109 may encode transmission data 105 and/or other information included in the information 101 provided by the gNB operations module 182. For example, encoding the data 105 and/or other information included in the information 101 may involve error detection and/or correction coding, mapping data to space, time and/or frequency resources for transmission, multiplexing, etc. The encoder 109 may provide encoded data 111 to the modulator 113. The transmission data 105 may include network data to be relayed to the UE 102.

The gNB operations module 182 may provide information 103 to the modulator 113. This information 103 may include instructions for the modulator 113. For example, the gNB operations module 182 may inform the modulator 113 of a modulation type (e.g., constellation mapping) to be used for transmissions to the UE(s) 102. The modulator 113 may modulate the encoded data 111 to provide one or more modulated signals 115 to the one or more transmitters 117.

The gNB operations module 182 may provide information 192 to the one or more transmitters 117. This information 192 may include instructions for the one or more transmitters 117. For example, the gNB operations module 182 may instruct the one or more transmitters 117 when to (or when not to) transmit a signal to the UE(s) 102. The one or more transmitters 117 may upconvert and transmit the modulated signal(s) 115 to one or more UEs 102.

It should be noted that a DL subframe may be transmitted from the gNB 160 to one or more UEs 102 and that a UL subframe may be transmitted from one or more UEs 102 to the gNB 160. Furthermore, both the gNB 160 and the one or more UEs 102 may transmit data in a standard special subframe.

It should also be noted that one or more of the elements or parts thereof included in the eNB(s) 160 and UE(s) 102 may be implemented in hardware. For example, one or more of these elements or parts thereof may be implemented as a chip, circuitry or hardware components, etc. It should also be noted that one or more of the functions or methods described herein may be implemented in and/or performed using hardware. For example, one or more of the methods described herein may be implemented in and/or realized using a chipset, an application-specific integrated circuit (ASIC), a large-scale integrated circuit (LSI) or integrated circuit, etc.

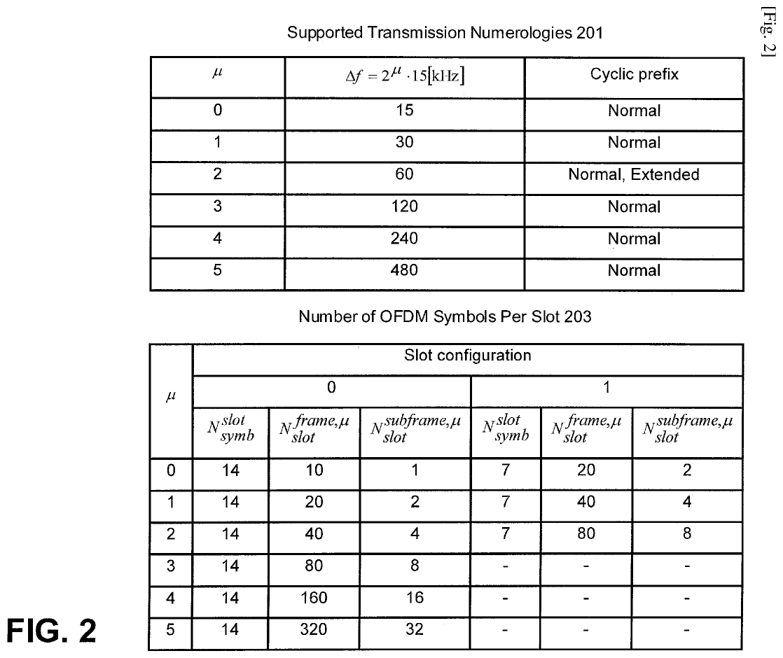

FIG. 2 shows examples of multiple numerologies 201. As shown in FIG. 2, multiple numerologies 201 (e.g., multiple subcarrier spacing) may be supported. For example, μ (e.g., a subcarrier space configuration) and a cyclic prefix (e.g., the μ and the cyclic prefix for a carrier bandwidth part) may be configured by higher layer parameters (e.g., a RRC message) for the downlink and/or the uplink. Here, 15 kHz may be a reference numerology 201. For example, an RE of the reference numerology 201 may be defined with a subcarrier spacing of 15 kHz in a frequency domain and 2048 Ts+CP length (e.g. 160 Ts or 144 Ts) in a time domain, where Ts denotes a baseband sampling time unit defined as 1/(15000*2048) seconds.
Additionally or alternatively, a number of OFDM symbol(s) 203 per slot (N_{symb}^{slot}) may be determined based on the μ (e.g., the subcarrier space configuration). Here, for example, a slot configuration 0 (e.g., the number of OFDM symbols 203 per slot may be 14) and/or a slot configuration (e.g., the number of OFDM symbols 203 per slot may be 7) may be defined.

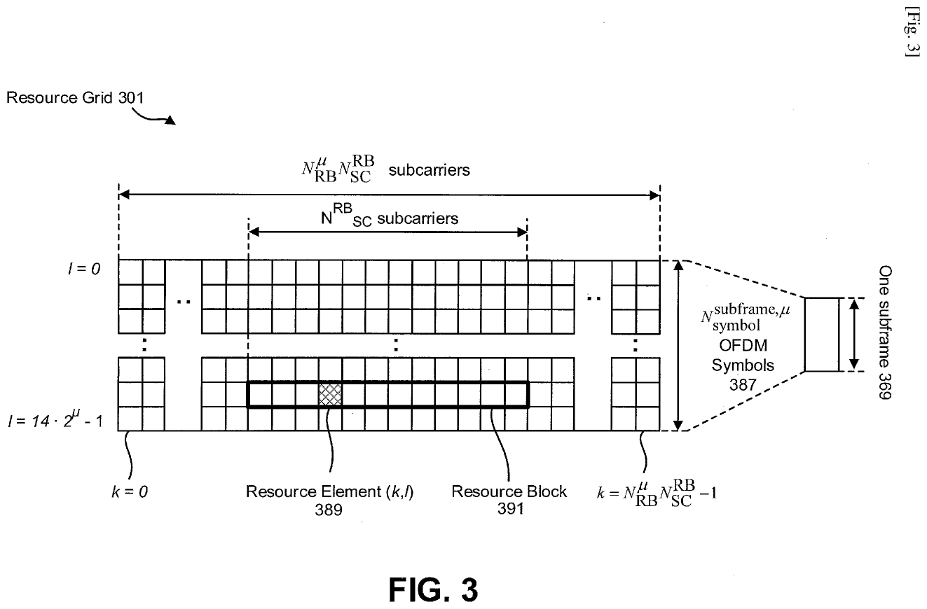

FIG. 3 is a diagram illustrating one example of a resource grid 301 and resource block 391 (e.g., for the downlink and/or the uplink). The resource grid 301 and resource block 391 illustrated in FIG. 3 may be utilized in some implementations of the systems and methods disclosed herein.
In FIG. 3, one subframe 369 may include N_{symbol}^{subframe,μ} symbols 387.

Additionally or alternatively, a resource block 391 may include a number of resource elements (RE) 389. Here, in the downlink, the OFDM access scheme with cyclic prefix (CP) may be employed, which may be also referred to as CP-OFDM. A downlink radio frame may include multiple pairs of downlink resource blocks (RBs) 391 which are also referred to as physical resource blocks (PRBs). The downlink RB pair is a unit for assigning downlink radio resources, defined by a predetermined bandwidth (RB bandwidth) and a time slot. The downlink RB pair may include two downlink RBs 391 that are continuous in the time domain. Additionally or alternatively, the downlink RB 391 may include twelve sub-carriers in frequency domain and seven (for normal CP) or six (for extended CP) OFDM symbols in time domain. A region defined by one sub-carrier in frequency domain and one OFDM symbol in time domain is referred to as a resource element (RE) 389 and is uniquely identified by the index pair (k,l), where k and I are indices in the frequency and time domains, respectively.

Additionally or alternatively, in the uplink, in addition to CP-OFDM, a Single-Carrier Frequency Division Multiple Access (SC-FDMA) access scheme may be employed, which is also referred to as Discrete Fourier Transform-Spreading OFDM (DFT-S-OFDM). An uplink radio frame may include multiple pairs of uplink resource blocks 391. The uplink RB pair is a unit for assigning uplink radio resources, defined by a predetermined bandwidth (RB bandwidth) and a time slot. The uplink RB pair may include two uplink RBs 391 that are continuous in the time domain. The uplink RB may include twelve sub-carriers in frequency domain and seven (for normal CP) or six (for extended CP) OFDM/DFT-S-OFDM symbols in time domain. A region defined by one sub-carrier in the frequency domain and one OFDM/DFT-S-OFDM symbol in the time domain is referred to as a resource element (RE) 389 and is uniquely identified by the index pair (k,l) in a slot, where k and l are indices in the frequency and time domains respectively.
Each element in the resource grid 301 (e.g., antenna port p) and the subcarrier configuration p is called a resource element 389 and is uniquely identified by the index pair (k,l) where k=0, . . . , N_{RB}^{μ}N_{SC}^{RB}−1 is the index in the frequency domain and l refers to the symbol position in the time domain. The resource element (k,l) 389 on the antenna port p and the subcarrier spacing configuration μ is denoted (k,l)ₚ,μ. The physical resource block 391 is defined as N_{SC}^{RB}=12 consecutive subcarriers in the frequency domain. The physical resource blocks 391 are numbered from 0 to N_{RB}^{μ}−1 in the frequency domain. The relation between the physical resource block number n_{PRB} in the frequency domain and the resource element (k,l) is given by

$$n P RB = ⌊ \frac{k}{{N}_{S C}^{R B}} ⌋ .$$

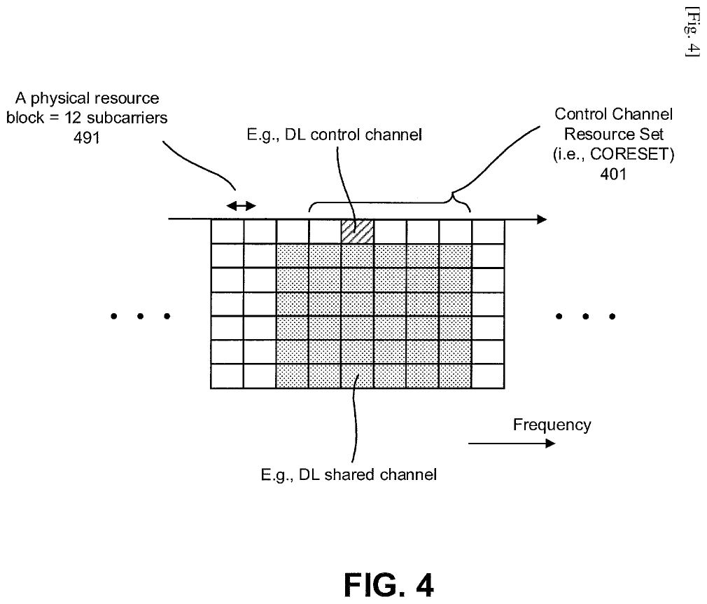

FIG. 4 shows examples of resource regions (e.g., resource region of the downlink). One or more sets 401 of PRB(s) 491 (e.g., a control resource set (e.g., CORESET)) may be configured for DL control channel monitoring (e.g., the PDCCH monitoring). For example, the CORESET is, in the frequency domain and/or the time domain, a set 401 of PRBs 491 within which the UE 102 attempts to decode the DCI (e.g., the DCI format(s), the PDCCH(s)), where the PRBs 491 may or may not be frequency contiguous and/or time contiguous, a UE 102 may be configured with one or more control resource sets (e.g., the CORESETs) and one DCI message may be mapped within one control resource set. In the frequency-domain, a PRB 491 is the resource unit size (which may or may not include DM-RS) for the DL control channel.

The UE 102 may monitor a set of candidates of the PDCCH (e.g., PDCCH candidates) in one or more control resource sets (e.g., CORESETs) on the active DL bandwidth part (BWP) on each activated serving cell according to corresponding search space sets. Here, the term “monitor” may imply that the UE 102 attempts to decode each PDCCH (e.g., the set of candidates of the PDCCH) according to the monitored DCI format(s). Also, the candidates of the PDCCH may be candidates for which the DL control channel(s) may possibly be mapped, assigned, and/or transmitted.

The set of candidates of the PDCCH for the UE 102 to monitor may be defined in terms of a search space set(s) (e.g., also referred to simply as a search space(s)). The UE 102 may monitor the set of candidates of the PDCCH in the search space(s). The search space set(s) may comprise a common search space(s) (CSS(s), UE-common search space(s)) and/or a user equipment-specific search space(s) (USS, UE-specific search space(s)).

Namely, the CSS and/or the USS may be defined (e.g., configured) in a region(s) of DL control channel(s). For example, the CSS may be used for transmission of DCI to a plurality of the UEs 102. For example, a Type0-PDCCH common search space may be defined for the DCI format(s) with CRC scrambled by the SI-RNTI. Additionally or alternatively, a Type1-PDCCH common search space may be defined for the DCI format(s) with CRC scrambled by the RA-RNTI, the Temporary C-RNTI, and/or the C-RNTI. Additionally or alternatively, a Type3-PDCCH common search space may be defined for the DCI format(s) with CRC scrambled by the C-RNTI, the CS-RNTI, the INT-RNTI, and/or the first RNTI.

The USS may be used for transmission of DCI to a specific UE 102. For example, the USS may be determined based on a Radio Network Temporary Identifier (RNTI) (e.g., the C-RNTI). For instance, the USS may be defined for the DCI format(s) with CRC scrambled by the C-RNTI, the CS-RNTI, the INT-RNTI, and/or the first RNTI.

Here, the gNB 160 may transmit, by using the RRC message, first information used for configuring (e.g., determining) one or more CORESETs. For example, for each of DL BWPs (e.g., each of DL BWPs in the serving cell), the gNB 106 may transmit, by using the RRC message, the first information used for configuring the one or more CORESET. For example, the first information may include information used for configuring an index of the CORESET. Also, the first information may include information used for configuring a number of consecutive symbols for the CORESET. Also, the first information may include information used for configuring a set of resource blocks for the CORESET.

Here, the index “0” of the CORESET (i.e., a value “0” of the CORESET, CORESET #0) may be configured by using the MIB and/or the SIB(s). For example, the index “0” of the CORESET may be used for identifying a common CORESET configured in the MIB and/or the SIB(s). Namely, the index of the CORESET except for the value “0” may be configured as the index of the CORESET. Also, the index of the CORESET with the value “0” may be configured by using information of a CORESET-zero. Also, the index “0” of the CORESET may be configured by using a dedicated RRC message (i.e., a UE-specific RRC message, and/or a serving cell-specific RRC message). Namely, the gNB 160 may transmit, by using the MIB, information used for configuring the CORESET with the index “0” (i.e., a CORESET #0). Additionally or alternatively, the gNB 160 may transmit, by using the SIB(s), the information used for configuring the CORESET #0. Additionally or alternatively, the gNB 160 may transmit, by using the dedicated RRC message, the information used for configuring the CORESET #0.

Here, the CORESET #0 may be configured for an initial BWP(s) (e.g., the initial DL BWP(s)). Here, the gNB 160 may transmit, by using the RRC message (e.g., the MIB, the SIB(s), and/or the dedicated RRC message), information used for the initial BWP(s) (e.g., the initial BWP(s)). Also, an index of the initial BWP(s) (e.g., the initial DL BWP(s)) may be “0”. Namely, the index “0” (e.g., the value “0”) may be applied (e.g., defined) for the initial BWP(s) (e.g., the initial DL BWP(s)). For example, (e.g., for the primary cell), the initial BWP(s) (i.e., the BWP with the index “0”) may be the BWP(s) used for an initial access. Additionally or alternately, (e.g., for the secondary cell(s)), the initial BWP(s) (i.e., the BWP(s) with the index “0”) may be the BWP(s) configured for the UE to first operate at the secondary cell(s) activation.

Here, the gNB 160 may transmit, by using the RRC message (e.g., the MIB, the SIB(s), and/or the dedicated RRC message), information used for configuring an index of the DL BWP(s) (e.g., the index other than the index “0”). Also, the gNB 160 may transmit, by using the RRC message (e.g., the MIB, the SIB(s), and/or the dedicated RRC message), information used for configuring an index of the UL BWP(s) (e.g., the index other than the index “0”). Namely, the index of the DL BWP(s) may be used for identifying the DL BWP(s). Also, the index of the UL BWP(s) may be used for identifying the UL BWP(s). The UE 102 may identify the DL BWP(s) based on the index of the DL BWP(s). Also, the UE 102 may identify the UL BWP(s) based on the index of the UL BWP(s).

As described above, the CORESET #0 may be referred to as the common CORESET. Also, the CORESET other than the CORESET #0 may be referred to as a UE-specific CORESET. Namely, the CORESET with the index “X (e.g., X=1, 2, 3, . . . )” other than the index “0” may be referred to as the UE-specific CORESET. For example, the gNB 160 may transmit, by using the dedicated RRC message, information used for configuring the UE-specific CORESET (e.g., the index of the UE-specific CORESET).

Additionally or alternatively, for each of the one or more CORESETs, the search space set(s) (e.g., the set(s) of the CSS(s) and/or the USS(s)) may be configured. Namely, the search space set(s) may be associated with the CORESET(s). For example, the UE 102 may monitor the PDCCH (e.g., the PDCCH candidates) in the CSS set(s) associated with the CORESET #0. Also, the UE 102 may monitor the PDCCH (e.g., the PDCCH candidates) in the CSS set(s) not associated with the CORESET #0. Also, the UE may monitor the PDCCH (e.g., the PDCCH candidates) in the USS (e.g., the USS not associated with the USS). Also, for example, the search space set(s) may be configured per DL BWP. Namely, the search space set(s) may be configured for each of the DL BWPs in the serving cell(s).

Additionally or alternatively, the gNB 160 may transmit, by using the RRC message, second information used for configuring the search space set(s). For example, the second information may be configured for each search space set. For example, the second information may include information used for configuring an index of the search space set(s). Additionally or alternatively, the second information may include information used for configuring the index of the CORESET(s) associated with the search space set(s). Additionally or alternatively, the second information may include information used for indicating a PDCCH monitoring periodicity and/or a PDCCH monitoring offset where the UE 102 monitors the PDCCH(s) in the search space set(s). Additionally or alternatively, the second information may include information used for indicating a PDCCH monitoring pattern within a slot. For example, the information used for indicating the PDCCH monitoring pattern may be used for indicating first symbol(s) within a slot for the PDCCH monitoring. For instance, the UE 102 may determine a PDCCH monitoring occasion(s) based on the PDCCH monitoring periodicity, the PDCCH monitoring offset, and/or the PDCCH monitoring pattern within a slot.

Additionally or alternatively, the second information may include information used for indicating a type of the search space set (e.g., information used for indicating that the search space set is either the CSS or the USS). Additionally or alternatively, the second information may include information used for indicating one or more DCI formats which accordingly the UE 102 monitors the PDCCH in the search space set(s). For example, if the search space set is the CSS (e.g., if the search space set is configured as the CSS), the DCI format 0_0 and/or the DCI format 1_0 may be configured to monitor the PDCCH (e.g., the candidate(s) of the PDCCH(s)). Additionally or alternatively, if the search space set is the CSS, the DCI format 2_1 and/or the DCI format 2_Y may be configured to monitor the PDCCH (e.g., the candidate(s) of the PDCCH(s)). Here, the DCI format(s) for monitoring the PDCCH in the CSS may be scrambled by the C-RNTI, the CS-RNTI, the RA-RNTI, the Temporary C-RNTI, the SI-RNTI, the INT-RNTI, and/or the first RNTI. For example, if the search space set is the CSS, the UE 102 may be configured to monitor the PDCCH (e.g., the candidates(s) of the PDCCH) for the DCI format 2_1 (e.g., with the CRC scrambled by the INT-RNTI) and/or the DCI format 2_Y (e.g., with the CRC scrambled by the C-RNTI, the INT-RNTI, and/or the first RNTI).

Additionally or alternatively, if the search space set is the USS (e.g., if the search space set is configured as the USS), the DCI format 0_0, the DCI format 1_0, the DCI format 0_Y, and/or the DCI format 1_X may be configured to monitor the PDCCH (e.g., the candidate(s) of the PDCCH(s)). Additionally or alternatively, if the search space set is the USS, the DCI format 0_1, the DCI format 1_1, the DCI format 0_Y, and/or the DCI format 1_X may be configured to monitor the PDCCH (e.g., the candidate(s) of the PDCCH(s)). For example, if the search space set is the USS, either of a first set of DCI formats (e.g., the DCI format 0_0, the DCI format 1_0, and/or the DCI format 0_Y, and/or the DCI format 1_X) or a second set of DCI formats (e.g., the DCI format 0_1, the DCI format 1_1, the DCI format 0_Y, and/or the DCI format 1_X) may be configured to monitor the PDCCH (e.g., the candidate(s) of the PDCCH(s)). For example, if the search space set is the USS, either of a third set of DCI formats (e.g., the DCI format 0_Y and/or the DCI format 1_X) or a fourth set of DCI formats (e.g., the DCI format 0_1 and/or the DCI format 1_1) may be configured to monitor the PDCCH. Also, if the search space set is the USS, either of a fifth set of DCI formats (e.g., the DCI format 0_Y and/or the DCI format 1_X) or a sixth set of DCI formats (e.g., the DCI format 0_0 and/or the DCI format 1_0) may be configured to monitor the PDCCH. Here, the DCI format(s) for monitoring the PDCCH in the USS may be scrambled by the C-RNTI, the CS-RNTI, and/or the first RNTI. For example, the second information may be configured per search space set. Namely, the second information may be configured for each of search space sets.

Here, the index “0” of the search space set (i.e., a value “0” of the search space set) may be configured by using the MIB and/or the SIB(s). For example, the index “0” of the search space set may be used for identifying a common search space set configured in the MIB and/or the SIB(s). Namely, the index of the search space set except for the value “0” may be configured as the index of the search space. Also, the index of the search space set with the value “0” may be configured by using information of search space-zero. Also, the index “0” of the search space set may be configured by using a dedicated RRC message (i.e., a UE-specific RRC message, and/or a serving cell-specific RRC message). Namely, the gNB 160 may transmit, by using the MIB, information used for configuring the search space set with the index “0” (i.e., the search space set #0). Additionally or alternatively, the gNB 160 may transmit, by using the SIB(s), the information used for configuring the search space set #0. Additionally or alternatively, the gNB 160 may transmit, by using the dedicated RRC message, the information used for configuring the search space set #0. Here, the search space set #0 may be configured for the initial BWP(s) (e.g., the initial DL BWP(s)).

As described above, the search space set #0 may be referred to as the common search space set. Also, the search space set other than the search space set #0 may be referred to as a UE-specific search space set. Namely, the search space set with the index “X (e.g., X=1, 2, 3, . . . )” other than the index “0” may be referred to as the UE-specific search space set. For example, the gNB 160 may transmit, by using the dedicated RRC message, information used for configuring the UE-specific search space set (e.g., the index of the UE-specific search space set).

Here, for example, for the serving cell(s), the gNB 160 may configure, by using the RRC message, a set of four DL BWPs (e.g., at most four DL BWPs, a DL BWP set) (e.g., for receptions by the UE 102). Additionally or alternatively, the gNB 160 may indicate, by using the DCI format(s) for the downlink, an active DL BWP(s). For example, for each DL BWP in the set of DL BWPs, the gNB 160 may configure, by using the RRC message, the subcarrier spacing, the cyclic prefix, a number of contiguous PRBs 491 (e.g., a bandwidth of PRBs), and/or an index (e.g., the index of the DL BWP(s)) in the set of DL BWPs.

Additionally or alternatively, for the serving cell(s), the gNB 160 may configure, by using the RRC message, a set of four UL BWP(s) (e.g., at most four UL BWPs, a UL BWP set) (e.g., for transmissions by the UE 102). Additionally or alternatively, the gNB 160 may indicate, by using the DCI format(s) for the uplink, an active UL BWP(s). Additionally or alternatively, for each UL BWP in the set of UL BWPs, the gNB 160 may configure, by using the RRC message, the subcarrier spacing, the cyclic prefix, a number of contiguous PRBs 491 (e.g., a bandwidth of PRBs), an index (e.g., the index of the UL BWP(s)) in the set of UL BWPs.

Additionally or alternatively, the UE 102 may perform, based on the configuration(s) for the DL BWP(s), reception(s) on the PDCCH in the DL BWP(s) and/or reception(s) on the PDSCH in the DL BWP(s). Additionally or alternatively, the UE 102 may perform, based on the configuration(s) for the UL BWP(s).

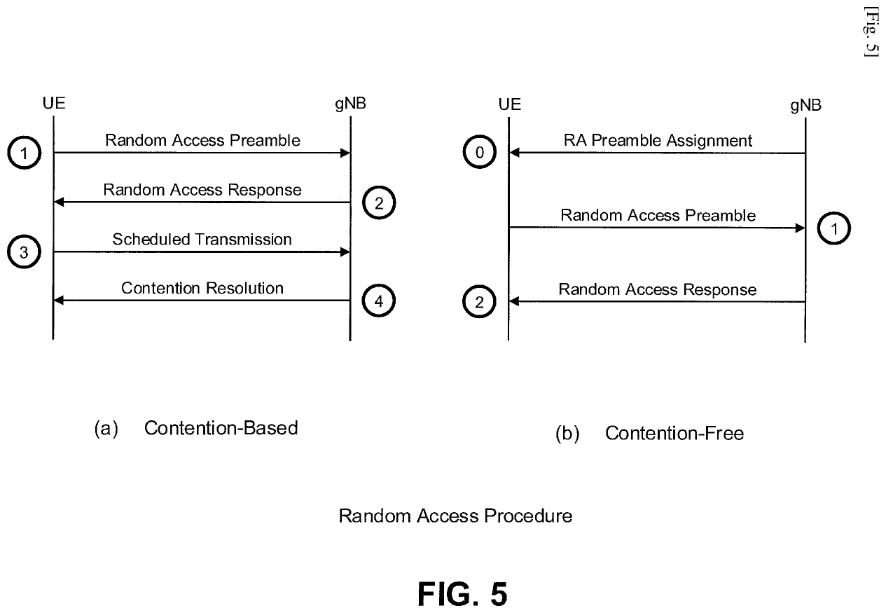

FIG. 5 illustrates an example of a random access procedure. As shown in FIG. 5, the random access procedure may take two distinct forms: contention-based random access (CBRA) (e.g., CBRA procedure) and contention-free random access (CFRA) (e.g., CFRA procedure).

For example the CBRA may include four steps (e.g., a message 1 (e.g., a Msg 1 as a first step), a message 2 (e.g., a Msg 2 as a second step), a message 3 (e.g., a Msg 3 as a third step), and a message 4 (e.g., a Msg 4 as a fourth step)).

For example, for the CBRA, the Msg 1 transmission (e.g., from the UE 102 to the gNB 160 in the uplink) may include a random access preamble transmission on the PRACH (e.g., the PRACH transmission). Here, for the Msg 1 transmission for the CBRA, the UE 102 may select a random access preamble randomly. For example, for the Msg 1 transmission for the CBRA, the UE 102 may select a random access preamble randomly with equal probability from random access preambles associated with a selected SS/PRB block(s) and/or a selected random access preamble group(s). Namely, for the CBRA, the UE 102 may transmit the random access preamble that is randomly selected.

Additionally or alternatively, for the CBRA, the Msg 2 transmission (e.g., from the gNB 160 to the UE 102 in the downlink) may include a random access response transmission on the DL-SCH (e.g., the PDSCH transmission). As described above, the PDSCH for the random access response transmission may be scheduled by using the PDCCH (e.g., the DCI format 1_0) with the CRC scrambled by the RA-RNTI. Additionally or alternatively, the random access response may include a random access response grant which is used for scheduling of the PUSCH (e.g., for the Msg 3 transmission). Additionally or alternatively, the random access response may include the temporary C-RNTI (e.g., a value of the temporary C-RNTI) which is used for scheduling of a retransmission on the PUSCH (e.g., for the Msg 3 retransmission).

Additionally or alternatively, for the CBRA, the Msg 3 transmission (e.g., from the UE 102 to the gNB 160 in the uplink) may include a scheduled transmission on the UL-SCH (e.g., the PUSCH transmission). Namely, the UE 102 may perform a transmission (e.g., an initial transmission) on the PUSCH that is scheduled by using the random access response grant. Additionally or alternately, the UE 102 may perform a transmission (e.g., a retransmission) on the PUSCH that is scheduled by using the PDCCH (e.g., the DCI format 1_0) with the CRC scrambled by the temporary C-RNTI.

Here, the Msg 3 for the CBRA may include the initial transmission on the PUSCH (e.g., the initial transmission of the Msg 3) and/or the retransmission on the PUSCH (e.g., the retransmission of the Msg 3). As described above, the initial transmission on the PUSCH (e.g., the initial transmission of the Msg 3) may be scheduled by using the random access response grant. Also, the initial transmission on the PUSCH (e.g., the initial transmission of the Msg 3) may be associated with the random access response grant. Also, the initial transmission on the PUSCH (e.g., the initial transmission of the Msg 3) may be associated with the PDCCH (e.g., the DCI format 1_0) with the CRC scrambled by the RA-RNTI. Also, the retransmission on the PUSCH (e.g., the retransmission of the Msg 3) may be associated with the PDCCH (e.g., the DCI format 1_0) with the CRC scrambled by the temporary C-RNTI.

Additionally or alternatively, the Msg 4 (e.g., from the gNB 160 to the UE 102 in the uplink) may include a contention resolution.

Additionally or alternately, the CFRA may include three steps (e.g., a message 0 (e.g., a Msg 0 as a first step), a message 1 (e.g., a Msg 1 as a second step), and a message 2 (e.g., a Msg 2 as a third step).

For example, for the CFRA, the Msg 0 transmission (e.g., from the gNB 160 to the UE 102 in the downlink) may include a random access preamble assignment (e.g., a RA preamble assignment). Namely, for the CFRA, the gNB 160 may assign (e.g., by using the PDCCH (e.g., the DCI format 1_0) with the CRC scrambled by the C-RNTI) to the UE 102 the random access preamble (e.g., for the random access preamble transmission on the PRACH in the Msg 1). For example, in a case that the CRC of the DCI format 1_0 is scrambled by the C-RNTI and the frequency domain resource assignment field are of all ones, the DCI format 1_0 (e.g., the DCI (e.g., a field(s) of the DCI) included in the DCI format 1_0) may be used for indicating an index of the random access preamble (e.g., a random access preamble index). Namely, for the CFRA, the index (e.g., the random access preamble index) corresponding to the random access preamble (e.g., for the Msg 1 transmission) may be assigned (e.g., provided, indicated, configured) to the UE 102. Namely, the CFRA (e.g., the CFRA procedure) may be initiated by a PDCCH order. Also, in a case that the CRC of the DCI format 1_0 is scrambled by the C-RNTI and the frequency domain resource assignment field are of all ones, the DCI format 1_0 may be for the random access procedure (e.g., the CFRA, the CFRA procedure).

Additionally or alternatively, for the CFRA, the UE 102 may perform the random access preamble transmission on the PRACH (e.g., the Msg 1 transmission) (e.g., from the UE 102 to the gNB 160 in the uplink). Here, for the CFRA, the UE 102 may transmit the random access preamble corresponding to the index (e.g., the random access preamble index) assigned.

Additionally or alternatively, for the CFRA, the Msg 2 transmission (e.g., from the gNB 160 to the UE 102 in the downlink) may include a random access response transmission on the DL-SCH (e.g., the PDSCH transmission). For example, for the CFRA, the PDSCH for the random access response transmission may be scheduled by using the PDCCH (e.g., the DCI format 1_0) with the CRC scrambled by the C-RNTI and/or the RA-RNTI. Additionally or alternatively, the random access response may include a random access response grant which is used for scheduling of the PUSCH. Additionally or alternatively, the random access response may include the temporary C-RNTI (e.g., a value of the temporary C-RNTI) which is used for scheduling of a retransmission on the PUSCH. Here, for the CFRA, the PUSCH transmission and/or the PUSCH retransmission corresponding to the random access response (e.g., the random access response grant) is not the Msg 3 transmission (e.g., for the CBRA).

Namely, based on the random access response (e.g., during the CFRA), the PUSCH transmission (e.g., from the UE 102 to the gNB 160 in the uplink) may be scheduled. Namely, the UE 102 may perform the PUSCH transmission associated with the CFRA. Additionally or alternately, the UE 102 may perform the PUSCH transmission associated with the random access response during the CFRA. Additionally or alternately, the UE 102 may perform the PUSCH transmission associated with the PDCCH (e.g., the DCI format 1_0) with the CRC scrambled by the C-RNTI. Additionally or alternately, the UE 102 may perform the PUSCH transmission associated with the preamble transmission assigned by the gNB 160. Additionally or alternately, the UE 102 may perform the PUSCH transmission associated with the PDCCH order.

As described above, for the CBRA (e.g., for relating the CBRA procedure), the UE 102 may perform the random access preamble transmission (e.g., on the PRACH). Namely, the UE 102 may perform the PRACH transmission associated with the CBRA. Additionally or alternatively, for the CBRA (e.g., for relating the CBRA procedure), the UE 102 may perform the PUSCH transmission. Here, the random access preamble transmission associated with the CBRA (i.e., the PRACH transmission associated with the CBRA) and/or the PUSCH transmission associated with the CBRA described herein may be assumed to be included in an uplink transmission associated with the CBRA (e.g., an UL transmission associated with the CBRA) in some implementations for the sake of simple descriptions.

Also, as described above, for the CFRA (e.g., for relating the CFRA procedure), the UE 102 may perform the random access preamble transmission (e.g., on the PRACH). Namely, the UE 102 may perform the PRACH transmission associated with the CFRA. Additionally or alternatively, for the CFRA (e.g., for relating the CFRA procedure), the UE 102 may perform the PUSCH transmission. Here, the random access preamble transmission associated with the CFRA (i.e., the PRACH transmission associated with the CFRA) and/or the PUSCH transmission associated with the CFRA described herein may be assumed to be included in an uplink transmission associated with the CFRA (e.g., an UL transmission associated with the CFRA) in some implementations for the sake of simple descriptions.

Additionally or alternatively, the random access procedure may be performed on the special cell. Additionally or alternatively, the random access procedure may be performed on a DL BWP (e.g., an active DL BWP) and an UL BWP (e.g., an active UL BWP). For example, in a case that PRACH resources (e.g., PRACH occasion(s)) are not configured for an active UL BWP, the UE 102 may switch the active UL BWP to an initial UL BWP (e.g., an UL BWP with the index “0”). Also, in a case that a serving cell is the special cell, the UE 102 may switch an active DL BWP to the initial DL BWP. Namely, the UE 102 may perform the random access procedure on the active DL BWP (e.g., the initial DL BWP (e.g., the DL BWP with the index “0”) of the special cell) and the active UL BWP (e.g., the initial UL BWP (e.g., the UL BWP with the index “0”) of the special cell).

Additionally or alternatively, in a case that PRACH resources (e.g., PRACH occasion(s)) are configured for an active UL BWP, and a service cell is the special cell, and an active DL BWP does not have the same index as the index of the UL BWP, the UE 102 may switch the active DL BWP to an active DL BWP with the same index as the index of the active UL BWP (i.e., the active UL BWP where the PRACH resources are configured). Namely, the UE 102 may perform the random access procedure on the active DL BWP and the active UL BWP (e.g., the index of the DL BWP may be the same as the index of the UL BWP).

As described in the detail above, the DCI format 2_1 and/or the INT-RNTI may be used for an interruption transmission indication for the downlink (e.g., no transmission is intended to the UE in the downlink). Namely, for example, the DCI format 2_1 (e.g., the DCI included in the DCI format 2_1) may be corresponding to the interruption transmission indication for the downlink. Also, the INT-RNTI may be corresponding to the interruption transmission indication for the downlink. Here, the interruption transmission indication for the downlink may be corresponding to a preemption indication for the downlink (e.g., a downlink preemption indication).

Additionally or alternatively, as described in the detail above, the DCI format 2_Y and/or the first RNTI may be used for an interruption transmission indication for the uplink (e.g., no transmission is allowed from the UE in the uplink, and/or the cancellation of the transmission in the uplink). Namely, for example, the DCI format 2_Y (e.g., the DCI included in the DCI format 2_Y) may be corresponding to the interruption transmission indication for the uplink. Also, the first RNTI may be corresponding to the interruption transmission indication for the uplink. Here, the interruption transmission indication for the uplink may be corresponding to a preemption indication for the uplink (e.g., an uplink preemption indication).

Additionally or alternatively, the gNB 160 may configure, by using the RRC message, third information related to the interrupted transmission indication for the downlink. For example, the gNB 160 may transmit, by using the RRC message, the third information used for configuring the UE 102 to monitor the interrupted transmission indication for the downlink (e.g., the PDCCH for the INT-RNTI (e.g., the DCI format 2_1 with the CRC scrambled by the INT-RNTI)).

For example, the third information may include information used for configuring a value of the INT-RNTI (e.g., a value of the INT-RNTI used for the interruption transmission indication (e.g., an indication preemption) for the downlink). Additionally or alternatively, the third information may include information used for configuring a time and/or frequency resource(s) for the interruption transmission indication for the downlink. Here, the time and/or frequency resource(s) for the interruption transmission indication for the downlink may be corresponding to the PRB(s) and/or the symbol(s) for the transmission(s) and/or no transmission(s) (e.g., in the downlink) (e.g., as described in the detail above). Additionally or alternatively, the time and/or frequency resource(s) for the interruption transmission indication for the downlink may be corresponding to an indication granularity for the time and/or frequency resource(s) (e.g., a granularity for the time and/or frequency resource(s) indicated by the interruption transmission indication for the downlink). Additionally or alternatively, the third information may include information used for configuring a total length of the DCI payload included in the DCI format 2_1 with the CRC scrambled by the INT-RNTI.

Additionally or alternatively, the third information may include information used for indicating a position(s) of a bit value(s) (e.g., 14 bit value(s)) inside the DCI payload (e.g., within the DCI payload, included in the DCI format 2_1 with the RC scrambled by the INT-RNTI). Here, the information may be used for indicating, per serving cell, the position(s) of the bit value(s). Namely, the gNB 106 may indicate, by using the information, the position(s) of the bit value(s) per serving cell (i.e., for each of the serving cells). Also, based on the information, the UE 102 may identify the position(s) of the bit value(s) per serving cell (i.e., for each of the serving cells). For example, the position(s) of the bit value(s) may be indicated based on information used for indicating an index of the serving cell(s). Also, the position(s) of the bit value(s) may be indicated based on information used for indicating a starting position(s) (e.g., in number of bit) of the bit value(s) (e.g., 14 bit value(s)) applicable for a serving cell with an index (e.g., the serving cell with the index configured by using the index of the serving cell(s)).

Additionally or alternatively, the gNB 160 may configure, by using the RRC message, fourth information related to the interrupted transmission indication for the uplink. Namely, the gNB 160 may separately configure, the third information (e.g., the first information for the interruption transmission indication for the downlink) and the fourth information (e.g., the second information for the interruption transmission indication for the uplink). For example, the gNB 160 may transmit, by using the RRC message, the fourth information used for configuring the UE 102 to monitor the interrupted transmission indication for the uplink (e.g., the PDCCH for the DCI format 2_Y (e.g., the DCI format 2_1 with the CRC scrambled by the first RNTI and/or the DCI format 2_X).

For example, the fourth information may include information used for configuring a value of the first RNTI (e.g., a value of the first RNTI used for the interruption transmission indication (e.g., an indication preemption) for the uplink). Additionally or alternatively, the fourth information may include information used for configuring a time and/or frequency resource(s) for the interruption transmission indication for the uplink. Here, the time and/or frequency resource(s) for the interruption transmission indication for the uplink may be corresponding to the PRB(s) and/or the symbol(s) for the transmission(s) and/or no transmission(s) (e.g., in the uplink) (e.g., as described in the detail above). Additionally or alternatively, the time and/or frequency resource(s) for the interruption transmission indication for the uplink may be corresponding to an indication granularity for the time and/or frequency resource(s) (e.g., a granularity for the time and/or frequency resource(s) indicated by the interruption transmission indication for the uplink). Additionally or alternatively, the second information may include information used for configuring a total length of the DCI payload included in the DCI format 2_Y.

Additionally or alternatively, the fourth information may include information used for indicating a position(s) of a bit value(s) (e.g., 14 bit value(s)) inside the DCI payload (e.g., within the DCI payload, included in the DCI format 2_Y). Here, the information may be used for indicating, per serving cell, the position(s) of the bit value(s). Namely, the gNB 106 may indicate, by using the information, the position(s) of the bit value(s) per serving cell (i.e., for each of the serving cells). Also, based on the information, the UE 102 may identify the position(s) of the bit value(s) per serving cell (i.e., for each of the serving cells). For example, the position(s) of the bit value(s) may be indicated based on information used for indicating an index of the serving cell(s). Also, the position(s) of the bit value(s) may be indicated based on information used for indicating a starting position(s) (e.g., in number of bit) of the bit value(s) (e.g., 14 bit value(s)) applicable for a serving cell with an index (e.g., the serving cell with the index (e.g., the index configured by using the index of the serving cell(s))).

Additionally or alternatively, the information (i.e., the information used for indicating the position(s) of the bit value(s) (e.g., 14 bit value(s)) inside the DCI payload (e.g., within the DCI payload, included in the DCI format 2_Y)) may be used for indicating, per BWP (e.g., UL BWP), the position(s) of the bit value(s). Namely, the gNB 106 may indicate, by using the information, the position(s) of the bit value(s) per BWP (e.g., UL BWP) (i.e., for each of the UL BWPs). Also, based on the information, the UE 102 may identify the position(s) of the bit value(s) per BWP (e.g., UL BWP) (i.e., for each of the UL BWPs). For example, the position(s) of the bit value(s) may be indicated based on information used for indicating an index of the BWP(s) (e.g., an index of the UL BWP). Also, the position(s) of the bit value(s) may be indicated based on information used for indicating a starting position(s) (e.g., in number of bit) of the bit value(s) (e.g., 14 bit value(s)) applicable for an UL BWP with an index (e.g., the UL BWP with the index (e.g., the index configured by using the index of the UL BWP(s))).

Here, the third information (e.g., and/or the information included in the third information) may be configured per serving cell. Namely, the third information (e.g., and/or the information included in the third information) may be configured for each of servicing cells (e.g., each of the primary cell, the primary secondary cell, and/or the secondary cell(s)). Additionally or alternatively, the fourth information (e.g., the information included in the fourth information) may be configured per serving cell. Namely, the fourth information (e.g., the information included in the fourth information) may be configured for each of servicing cells (e.g., each of the primary cell, the primary secondary cell, and/or the secondary cell(s)).

Additionally or alternatively, the fourth information (e.g., the information included in the fourth information) may be configured per BWP (e.g., per UL BWP). Namely, the fourth information (e.g., the information included in the fourth information) may be configured for each of BWPs (e.g., each of the UL BWPs).

Additionally or alternatively, the interruption transmission indication for the downlink may be applicable to a reception(s) on the PDSCH (e.g., only a reception(s) of the PDSCH). Namely, for the reception on the PDSCH, the UE 102 may assume that no transmission (e.g., on the PDSCH) is intended to the UE. Namely, for the reception on the PDSCH, in a case that the UE 102 detects the interruption transmission indication for the downlink for the serving cell(s), the UE 102 may assume (e.g., always assume) that no transmission (e.g., on the PDSCH) to the UE 102 is present in the PRB(s) and/or symbol(s) that are indicated by the interruption transmission indication for the downlink (as described in the detail above).

Additionally or alternatively, the interruption transmission indication for the downlink may not be applicable to a reception(s) of a SS/PBCH block(s). Namely, for the reception of the SS/PBCH block(s), the UE 102 may not assume that no transmission (e.g., of the SS/PBCH block(s)) is intended to the UE. Namely, for the reception of the SS/PBCH block(s), even if the UE 102 detects the interruption transmission indication for the downlink (e.g., even if the PRB(s) and/or the symbol(s) are indicated by the interruption transmission indication), the UE 102 may not assume no transmission (e.g., of the SS/PRB block(s)) to the UE is present in the PRB(s) and/or the symbol(s). Namely, (e.g., regardless of the detection of the interruption transmission indication for the downlink), the UE 102 may always assume that the transmission (e.g., of the SS/PBCH block(s)) to the UE is present in the PRB(s) and/or the symbol(s).

As described above, the UL signal(s) (e.g., the UL signal(s) transmission) may include, at least, the PRACH transmission(s) (e.g., the Msg 1 transmission associated with the CBRA, and/or the Msg 1 transmission associated with the CFRA), the PUSCH transmission(s) (e.g., the first PUSCH transmission, the PUSCH transmission associated with the CBRA, and/or the PUSCH transmission associates with the CFRA), the PUCCH transmission, and/or the SRS transmission. Here, as described above, the first PUSCH transmission is different from the PUSCH transmission associated with the CBRA and the PUSCH transmission associated with the CFRA.

Additionally or alternatively, the interruption transmission indication for the uplink may be applicable to the PUSCH transmission (e.g., only the PUSCH transmission). Namely, based on the interruption transmission indication for the uplink, the UE 102 may not be allowed to perform the PUSCH transmission (as described in the detail above). Namely, based on the interruption transmission indication for the uplink, the UE 102 may cancel the PUSCH transmission (e.g., stop performing the PUSCH transmission) (as described in the detail above). Namely, in a case that the UE 102 detects the interruption transmission indication for the uplink (e.g., for the serving cell(s) and/or the UL BWP(s)), the UE 102 may not be allowed to perform the PUSCH transmission in the PRB(s) and/or symbol(s) that are indicated by the interruption transmission indication for the uplink (as described in the detail above). Also, in a case that the UE 102 detects the interruption transmission indication for the uplink (e.g., for the serving cell(s) and/or the UL BWP(s)), the UE 102 may cancel the PUSCH transmission in the PRB(s) and/or symbol(s) that are indicated by the interruption transmission indication for the uplink (as described in the detail above).

Here, the interruption transmission indication for the uplink may be applicable to the first PUSCH transmission (e.g., only the first PUSCH transmission). Additionally or alternatively, the interruption transmission indication for the uplink may be applicable to the first PUSCH transmission and the PUSCH transmission associated with the CBRA (e.g., only the first PUSCH transmission). Namely, the interruption transmission indication for the uplink may not be applicable to the PUSCH transmission associated with the CFRA. Also, the interruption transmission indication for the uplink may not be applicable to the PUSCH transmission associated with the CBRA and/or the PUSCH transmission associated with the CFRA.

Namely, based on the interruption transmission indication for the uplink, the UE 102 may not be allowed to perform the first PUSCH transmission and/or the PUSCH transmission associated with the CBRA (as described in the detail above). Namely, based on the interruption transmission indication for the uplink, the UE 102 may cancel the first PUSCH transmission and/or the PUSCH transmission associated with the CBRA (e.g., stop performing the first PUSCH transmission and/or the PUSCH transmission associated with the CBRA) (as described in the detail above). Namely, in a case that the UE 102 detects the interruption transmission indication for the uplink (e.g., for the serving cell(s) and/or the UL BWP(s)), the UE 102 may not be allowed to perform the first PUSCH transmission (and/or the PUSCH transmission associated with the CBRA) in the PRB(s) and/or symbol(s) that are indicated by the interruption transmission indication for the uplink (as described in the detail above). Also, in a case that the UE 102 detects the interruption transmission indication for the uplink (e.g., for the serving cell(s) and/or the UL BWP(s)), the UE 102 may cancel the PUSCH transmission (and/or the PUSCH transmission associated with the CBRA) in the PRB(s) and/or symbol(s) that are indicated by the interruption transmission indication for the uplink (as described in the detail above).

Additionally or alternatively, the UE 102 may be allowed (e.g., always allowed) to perform the PUSCH transmission associated with the CFRA. Namely, the UE 102 may not cancel (e.g., always not cancel) the PUSCH transmission associated with the CFRA. Namely, even if the UE 102 detects the interruption transmission indication for the uplink, the UE 102 may be allowed (e.g., always allowed) to perform the PUSCH transmission associated with the CFRA (i.e., the interruption transmission indication for the uplink may not applicable to the PUSCH transmission associated with the CFRA). Also, even if the UE 102 detects the interruption transmission indication for the uplink, the UE 102 may not cancel (e.g., always not cancel) the PUSCH transmission associated with the CFRA (i.e., the interruption transmission indication for the uplink may not applicable to the PUSCH transmission associated with the CFRA). For example, (e.g., regardless of the detection of the interruption transmission indication for the uplink), the UE 102 may be allowed to perform the PUSCH transmission associated with the CFRA (e.g., in the PRB(s) and/or the symbol(s)). Also, (e.g., regardless of the detection of the interruption transmission indication for the uplink), the UE 102 may not cancel the PUSCH transmission associated with the CFRA (e.g., in the PRB(s) and/or the symbol(s)).

Additionally or alternatively, the UE 102 may be allowed (e.g., always allowed) to perform the PUSCH transmission associated with the CFRA and/or the PUSCH transmission associated with the CBRA. Namely, the UE 102 may not cancel (e.g., always not cancel) the PUSCH transmission associated with the CFRA and/or the PUSCH transmission associated with the CBRA. Namely, even if the UE 102 detects the interruption transmission indication for the uplink, the UE 102 may be allowed (e.g., always allowed) to perform the PUSCH transmission associated with the CFRA and/or the PUSCH transmission associated with the CBRA (i.e., the interruption transmission indication for the uplink may not applicable to the PUSCH transmission associated with the CFRA and/or the PUSCH transmission associated with the CBRA). Also, even if the UE 102 detects the interruption transmission indication for the uplink, the UE 102 may not cancel (e.g., always not cancel) the PUSCH transmission associated with the CFRA and the PUSCH transmission associated with the CBRA (i.e., the interruption transmission indication for the uplink may not applicable to the PUSCH transmission associated with the CFRA and/or the PUSCH transmission associated with the CBRA). For example, (e.g., regardless of the detection of the interruption transmission indication for the uplink), the UE 102 may be allowed to perform the PUSCH transmission associated with the CFRA and/or the PUSCH transmission associated with the CBRA (e.g., in the PRB(s) and/or the symbol(s)). Also, (e.g., regardless of the detection of the interruption transmission indication for the uplink), the UE 102 may not cancel the PUSCH transmission associated with the CFRA and/or the PUSCH transmission associated with the CBRA (e.g., in the PRB(s) and/or the symbol(s)).

Additionally or alternatively, the interruption transmission indication for the uplink may be applicable to the PRACH transmission. Namely, based on the interruption transmission indication for the uplink, the UE 102 may not be allowed to perform the PRACH transmission (as described in the detail above). Namely, based on the interruption transmission indication for the uplink, the UE 102 may cancel the PRACH transmission (e.g., stop performing the PRACH transmission) (as described in the detail above). Namely, in a case that the UE 102 detects the interruption transmission indication for the uplink (e.g., for the serving cell(s) and/or the UL BWP(s)), the UE 102 may not be allowed to perform the PRACH transmission in the PRB(s) and/or symbol(s) that are indicated by the interruption transmission indication for the uplink (as described in the detail above). Also, in a case that the UE 102 detects the interruption transmission indication for the uplink (e.g., for the serving cell(s) and/or the UL BWP(s)), the UE 102 may cancel the PRACH transmission in the PRB(s) and/or symbol(s) that are indicated by the interruption transmission indication for the uplink (as described in the detail above).

Additionally or alternatively, the interruption transmission indication for the uplink may not be applicable to the PRACH transmission. Namely, the UE 102 may be allowed (e.g., always allowed) to perform the PRACH transmission. Namely, the UE 102 may not cancel (e.g., always not cancel) the PRACH transmission. Namely, even if the UE 102 detects the interruption transmission indication for the uplink, the UE 102 may be allowed (e.g., always allowed) to perform the PRACH transmission (i.e., the interruption transmission indication for the uplink may not applicable to the PRACH transmission). Also, even if the UE 102 detects the interruption transmission indication for the uplink, the UE 102 may not cancel (e.g., always not cancel) the PRACH transmission (i.e., the interruption transmission indication for the uplink may not applicable to the PRACH transmission). For example, (e.g., regardless of the detection of the interruption transmission indication for the uplink), the UE 102 may be allowed to perform the PRACH transmission (e.g., in the PRB(s) and/or the symbol(s)). Also, (e.g., regardless of the detection of the interruption transmission indication for the uplink), the UE 102 may not cancel the PRACH transmission (e.g., in the PRB(s) and/or the symbol(s)).

Additionally or alternatively, the interruption transmission indication for the uplink may be applicable to the PRACH transmission associated with the CBRA. Namely, the interruption transmission indication for the uplink may not be applicable to the PRACH transmission associated with the CFRA.

Namely, based on the interruption transmission indication for the uplink, the UE 102 may not be allowed to perform the PRACH transmission associated with the CBRA (as described in the detail above). Namely, based on the interruption transmission indication for the uplink, the UE 102 may cancel the PRACH transmission associated with the CBRA (e.g., stop performing the PRACH transmission associated with the CBRA) (as described in the detail above). Namely, in a case that the UE 102 detects the interruption transmission indication for the uplink (e.g., for the serving cell(s) and/or the UL BWP(s)), the UE 102 may not be allowed to perform the PRACH transmission associated with the CBRA in the PRB(s) and/or symbol(s) that are indicated by the interruption transmission indication for the uplink (as described in the detail above). Also, in a case that the UE 102 detects the interruption transmission indication for the uplink (e.g., for the serving cell(s) and/or the UL BWP(s)), the UE 102 may cancel the PRACH transmission associated with the CBRA in the PRB(s) and/or symbol(s) that are indicated by the interruption transmission indication for the uplink (as described in the detail above).

Additionally or alternatively, the UE 102 may be allowed (e.g., always allowed) to perform the PRACH transmission associated with the CFRA. Namely, the UE 102 may not cancel (e.g., always not cancel) the PRACH transmission associated with the CFRA. Namely, even if the UE 102 detects the interruption transmission indication for the uplink, the UE 102 may be allowed (e.g., always allowed) to perform the PRACH transmission associated with the CFRA (i.e., the interruption transmission indication for the uplink may not applicable to the PRACH transmission associated with the CFRA). Also, even if the UE 102 detects the interruption transmission indication for the uplink, the UE 102 may not cancel (e.g., always not cancel) the PRACH transmission associated with the CFRA (i.e., the interruption transmission indication for the uplink may not applicable to the PRACH transmission associated with the CFRA). For example, (e.g., regardless of the detection of the interruption transmission indication for the uplink), the UE 102 may be allowed to perform the PRACH transmission associated with the CFRA (e.g., in the PRB(s) and/or the symbol(s)). Also, (e.g., regardless of the detection of the interruption transmission indication for the uplink), the UE 102 may not cancel the PRACH transmission associated with the CFRA (e.g., in the PRB(s) and/or the symbol(s)).

Additionally or alternatively, the interruption transmission indication for the uplink may be applicable to the UL transmission associated with the CBRA. Namely, the interruption transmission indication for the uplink may not be applicable to the UL transmission associated with the CFRA.

Namely, based on the interruption transmission indication for the uplink, the UE 102 may not be allowed to perform the UL transmission associated with the CBRA (as described in the detail above). Namely, based on the interruption transmission indication for the uplink, the UE 102 may cancel the UL transmission associated with the CBRA (e.g., stop performing the UL transmission associated with the CBRA) (as described in the detail above). Namely, in a case that the UE 102 detects the interruption transmission indication for the uplink (e.g., for the serving cell(s) and/or the UL BWP(s)), the UE 102 may not be allowed to perform the UL transmission associated with the CBRA in the PRB(s) and/or symbol(s) that are indicated by the interruption transmission indication for the uplink (as described in the detail above). Also, in a case that the UE 102 detects the interruption transmission indication for the uplink (e.g., for the serving cell(s) and/or the UL BWP(s)), the UE 102 may cancel the UL transmission associated with the CBRA in the PRB(s) and/or symbol(s) that are indicated by the interruption transmission indication for the uplink (as described in the detail above).

Additionally or alternatively, the UE 102 may be allowed (e.g., always allowed) to perform the UL transmission associated with the CFRA. Namely, the UE 102 may not cancel (e.g., always not cancel) the UL transmission associated with the CFRA. Namely, even if the UE 102 detects the interruption transmission indication for the uplink, the UE 102 may be allowed (e.g., always allowed) to perform the UL transmission associated with the CFRA (i.e., the interruption transmission indication for the uplink may not applicable to the UL transmission associated with the CFRA). Also, even if the UE 102 detects the interruption transmission indication for the uplink, the UE 102 may not cancel (e.g., always not cancel) the UL transmission associated with the CFRA (i.e., the interruption transmission indication for the uplink may not applicable to the UL transmission associated with the CFRA). For example, (e.g., regardless of the detection of the interruption transmission indication for the uplink), the UE 102 may be allowed to perform the UL transmission associated with the CFRA (e.g., in the PRB(s) and/or the symbol(s)). Also, (e.g., regardless of the detection of the interruption transmission indication for the uplink), the UE 102 may not cancel the UL transmission associated with the CFRA (e.g., in the PRB(s) and/or the symbol(s)).

Additionally or alternatively, the interruption transmission indication for the uplink may be applicable to the PUCCH transmission. Namely, based on the interruption transmission indication for the uplink, the UE 102 may not be allowed to perform the PUCCH transmission (as described in the detail above). Namely, based on the interruption transmission indication for the uplink, the UE 102 may cancel the PUCCH transmission (as described in the detail above). Namely, in a case that the UE 102 detects the interruption transmission indication for the uplink (e.g., for the serving cell(s) and/or the UL BWP(s)), the UE 102 may not be allowed to perform the PUCCH transmission in the PRB(s) and/or symbol(s) that are indicated by the interruption transmission indication for the uplink (as described in the detail above). Also, in a case that the UE 102 detects the interruption transmission indication for the uplink (e.g., for the serving cell(s) and/or the UL BWP(s)), the UE 102 may cancel the PUCCH transmission in the PRB(s) and/or symbol(s) that are indicated by the interruption transmission indication for the uplink (as described in the detail above).

Additionally or alternatively, the interruption transmission indication for the uplink may not be applicable to the PUCCH transmission. Namely, the UE 102 may be allowed (e.g., always allowed) to perform the PUCCH transmission. Namely, the UE 102 may not cancel (e.g., always not cancel) the PUCCH transmission. Namely, even if the UE 102 detects the interruption transmission indication for the uplink, the UE 102 may be allowed (e.g., always allowed) to perform the PUCCH transmission (i.e., the interruption transmission indication for the uplink may not applicable to the PUCCH transmission). Also, even if the UE 102 detects the interruption transmission indication for the uplink, the UE 102 may not cancel (e.g., always not cancel) the PUCCH transmission (i.e., the interruption transmission indication for the uplink may not applicable to the PUCCH transmission). For example, (e.g., regardless of the detection of the interruption transmission indication for the uplink), the UE 102 may be allowed to perform the PUCCH transmission (e.g., in the PRB(s) and/or the symbol(s)). Also, (e.g., regardless of the detection of the interruption transmission indication for the uplink), the UE 102 may not cancel the PUCCH transmission (e.g., in the PRB(s) and/or the symbol(s)).

Additionally or alternatively, the interruption transmission indication for the uplink may be applicable to the SRS transmission. Namely, based on the interruption transmission indication for the uplink, the UE 102 may not be allowed to perform the SRS transmission (as described in the detail above). Namely, based on the interruption transmission indication for the uplink, the UE 102 may cancel the SRS transmission (as described in the detail above). Namely, in a case that the UE 102 detects the interruption transmission indication for the uplink (e.g., for the serving cell(s) and/or the UL BWP(s)), the UE 102 may not be allowed to perform the SRS transmission in the PRB(s) and/or symbol(s) that are indicated by the interruption transmission indication for the uplink (as described in the detail above). Also, in a case that the UE 102 detects the interruption transmission indication for the uplink (e.g., for the serving cell(s) and/or the UL BWP(s)), the UE 102 may cancel the SRS transmission in the PRB(s) and/or symbol(s) that are indicated by the interruption transmission indication for the uplink (as described in the detail above).

Additionally or alternatively, the interruption transmission indication for the uplink may not be applicable to the SRS transmission. Namely, the UE 102 may be allowed (e.g., always allowed) to perform the SRS transmission. Namely, the UE 102 may not cancel (e.g., always not cancel) the SRS transmission. Namely, even if the UE 102 detects the interruption transmission indication for the uplink, the UE 102 may be allowed (e.g., always allowed) to perform the SRS transmission (i.e., the interruption transmission indication for the uplink may not applicable to the SRS transmission). Also, even if the UE 102 detects the interruption transmission indication for the uplink, the UE 102 may not cancel (e.g., always not cancel) the SRS transmission (i.e., the interruption transmission indication for the uplink may not applicable to the SRS transmission). For example, (e.g., regardless of the detection of the interruption transmission indication for the uplink), the UE 102 may be allowed to perform the SRS transmission (e.g., in the PRB(s) and/or the symbol(s)). Also, (e.g., regardless of the detection of the interruption transmission indication for the uplink), the UE 102 may not cancel the SRS transmission (e.g., in the PRB(s) and/or the symbol(s)).

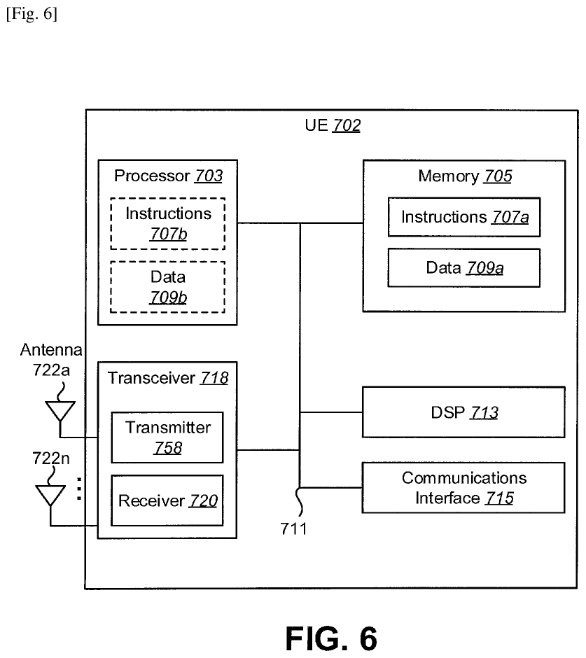

FIG. 6 illustrates various components that may be utilized in a UE 702. The UE 702 described in connection with FIG. 6 may be implemented in accordance with the UE 102 described in connection with FIG. 1. The UE 702 includes a processor 703 that controls operation of the UE 702. The processor 703 may also be referred to as a central processing unit (CPU). Memory 705, which may include read-only memory (ROM), random access memory (RAM), a combination of the two or any type of device that may store information, provides instructions 707a and data 709a to the processor 703. A portion of the memory 705 may also include non-volatile random access memory (NVRAM). Instructions 707b and data 709b may also reside in the processor 703. Instructions 707b and/or data 709b loaded into the processor 703 may also include instructions 707a and/or data 709a from memory 705 that were loaded for execution or processing by the processor 703. The instructions 707b may be executed by the processor 703 to implement the methods described herein.

The UE 702 may also include a housing that contains one or more transmitters 758 and one or more receivers 720 to allow transmission and reception of data. The transmitter(s) 758 and receiver(s) 720 may be combined into one or more transceivers 718. One or more antennas 722a-n are attached to the housing and electrically coupled to the transceiver 718.

The various components of the UE 702 are coupled together by a bus system 711, which may include a power bus, a control signal bus and a status signal bus, in addition to a data bus. However, for the sake of clarity, the various buses are illustrated in FIG. 6 as the bus system 711. The UE 702 may also include a digital signal processor (DSP) 713 for use in processing signals. The UE 702 may also include a communications interface 715 that provides user access to the functions of the UE 702. The UE 702 illustrated in FIG. 6 is a functional block diagram rather than a listing of specific components.

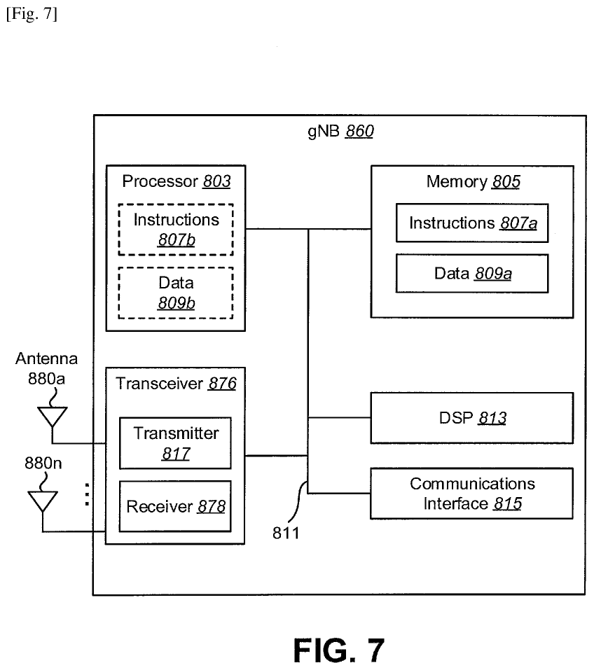

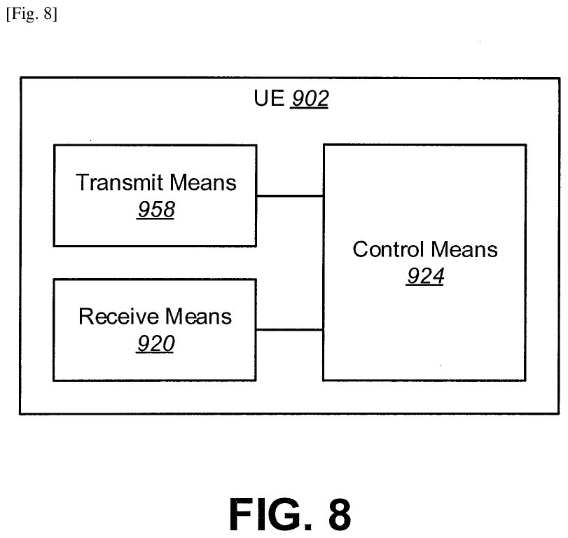

FIG. 7 illustrates various components that may be utilized in a gNB 860. The gNB 860 described in connection with FIG. 8 may be implemented in accordance with the gNB 160 described in connection with FIG. 1. The gNB 860 includes a processor 803 that controls operation of the gNB 860. The processor 803 may also be referred to as a central processing unit (CPU). Memory 805, which may include read-only memory (ROM), random access memory (RAM), a combination of the two or any type of device that may store information, provides instructions 807a and data 809a to the processor 803. A portion of the memory 805 may also include non-volatile random access memory (NVRAM). Instructions 807b and data 809b may also reside in the processor 803. Instructions 807b and/or data 809b loaded into the processor 803 may also include instructions 807a and/or data 809a from memory 805 that were loaded for execution or processing by the processor 803. The instructions 807b may be executed by the processor 803 to implement the methods described herein.

The gNB 860 may also include a housing that contains one or more transmitters 817 and one or more receivers 878 to allow transmission and reception of data. The transmitter(s) 817 and receiver(s) 878 may be combined into one or more transceivers 876. One or more antennas 880a-n are attached to the housing and electrically coupled to the transceiver 876.

The various components of the gNB 860 are coupled together by a bus system 811, which may include a power bus, a control signal bus and a status signal bus, in addition to a data bus. However, for the sake of clarity, the various buses are illustrated in FIG. 7 as the bus system 811. The gNB 860 may also include a digital signal processor (DSP) 813 for use in processing signals. The gNB 860 may also include a communications interface 815 that provides user access to the functions of the gNB 860. The gNB 860 illustrated in FIG. 8 is a functional block diagram rather than a listing of specific components.

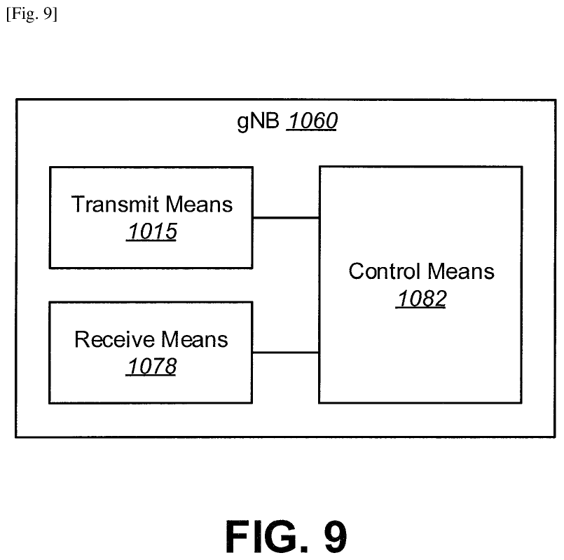

FIG. 8 is a block diagram illustrating one implementation of a UE 902 in which one or more of the systems and/or methods described herein may be implemented. The UE 902 includes transmit means 958, receive means 920 and control means 924. The transmit means 958, receive means 920 and control means 924 may be configured to perform one or more of the functions described in connection with FIG. 1 above. FIG. 7 above illustrates one example of a concrete apparatus structure of FIG. 9. Other various structures may be implemented to realize one or more of the functions of FIG. 1. For example, a DSP may be realized by software.

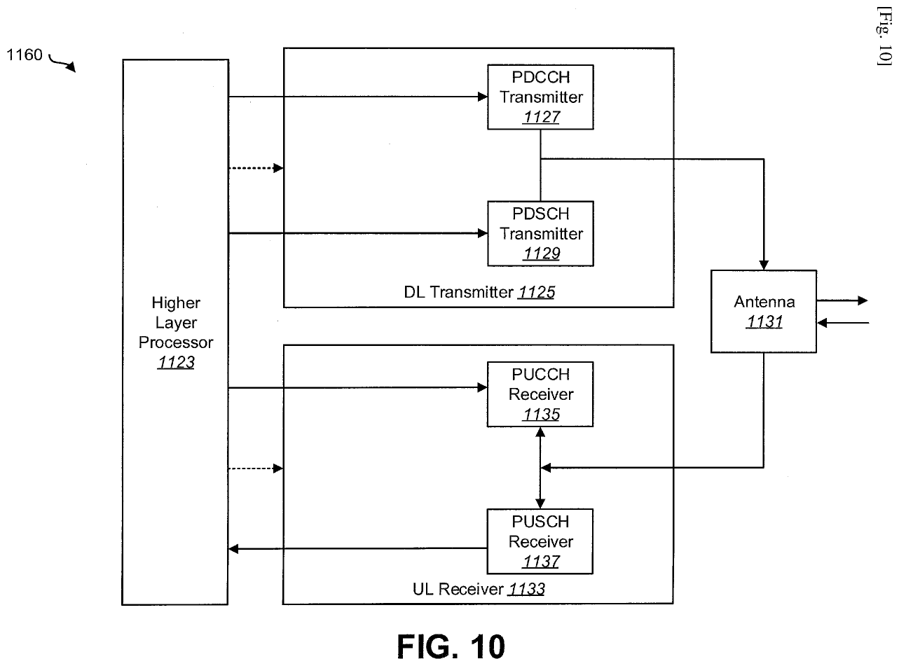

FIG. 9 is a block diagram illustrating one implementation of a gNB 1060 in which one or more of the systems and/or methods described herein may be implemented. The gNB 1060 includes transmit means 1017, receive means 1078 and control means 1082. The transmit means 1017, receive means 1078 and control means 1082 may be configured to perform one or more of the functions described in connection with FIG. 1 above. FIG. 8 above illustrates one example of a concrete apparatus structure of FIG. 10. Other various structures may be implemented to realize one or more of the functions of FIG. 1. For example, a DSP may be realized by software.

FIG. 10 is a block diagram illustrating one implementation of a gNB 1160. The gNB 1160 may be an example of the gNB 160 described in connection with FIG. 1. The gNB 1160 may include a higher layer processor 1123, a DL transmitter 1125, a UL receiver 1133, and one or more antenna 1131. The DL transmitter 1125 may include a PDCCH transmitter 1127 and a PDSCH transmitter 1129. The UL receiver 1133 may include a PUCCH receiver 1135 and a PUSCH receiver 1137.

The higher layer processor 1123 may manage physical layer's behaviors (the DL transmitter's and the UL receiver's behaviors) and provide higher layer parameters to the physical layer. The higher layer processor 1123 may obtain transport blocks from the physical layer. The higher layer processor 1123 may send/acquire higher layer messages such as an RRC message and MAC message to/from a UE's higher layer. The higher layer processor 1123 may provide the PDSCH transmitter transport blocks and provide the PDCCH transmitter transmission parameters related to the transport blocks.

The DL transmitter 1125 may multiplex downlink physical channels and downlink physical signals (including reservation signal) and transmit them via transmission antennas 1131. The UL receiver 1133 may receive multiplexed uplink physical channels and uplink physical signals via receiving antennas 1131 and de-multiplex them. The PUCCH receiver 1135 may provide the higher layer processor 1123 UCI. The PUSCH receiver 1137 may provide the higher layer processor 1123 received transport blocks.

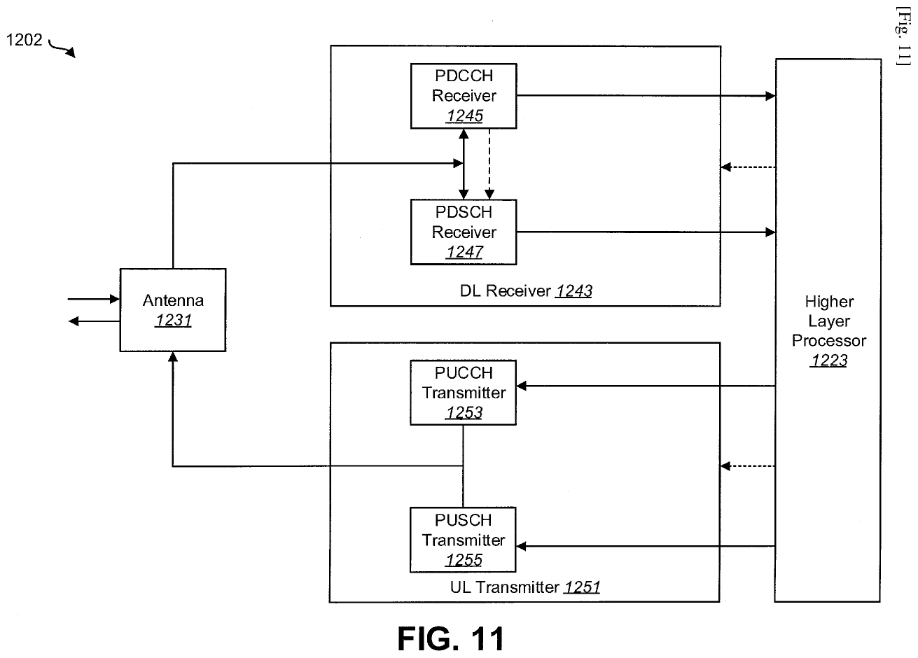

FIG. 11 is a block diagram illustrating one implementation of a UE 1202. The UE 1202 may be an example of the UE 102 described in connection with FIG. 1. The UE 1202 may include a higher layer processor 1223, a UL transmitter 1251, a DL receiver 1243, and one or more antenna 1231. The UL transmitter 1251 may include a PUCCH transmitter 1253 and a PUSCH transmitter 1255. The DL receiver 1243 may include a PDCCH receiver 1245 and a PDSCH receiver 1247.

The higher layer processor 1223 may manage physical layer's behaviors (the UL transmitter's and the DL receiver's behaviors) and provide higher layer parameters to the physical layer. The higher layer processor 1223 may obtain transport blocks from the physical layer. The higher layer processor 1223 may send/acquire higher layer messages such as an RRC message and MAC message to/from a UE's higher layer. The higher layer processor 1223 may provide the PUSCH transmitter transport blocks and provide the PUCCH transmitter 1253 UCI.

The DL receiver 1243 may receive multiplexed downlink physical channels and downlink physical signals via receiving antennas 1231 and de-multiplex them. The PDCCH receiver 1245 may provide the higher layer processor 1223 DCI. The PDSCH receiver 1247 may provide the higher layer processor 1223 received transport blocks.

As described herein, some methods for the DL and/or UL transmissions may be applied (e.g., specified). Here, the combination of one or more of the some methods described herein may be applied for the DL and/or UL transmission. The combination of the one or more of the some methods described herein may not be precluded in the described systems and methods.

It should be noted that names of physical channels described herein are examples. The other names such as “NRPDCCH, NRPDSCH, NRPUCCH and NRPUSCH,” “new Generation-(G)PDCCH, GPDSCH, GPUCCH and GPUSCH” or the like can be used.

The term “computer-readable medium” refers to any available medium that can be accessed by a computer or a processor. The term “computer-readable medium,” as used herein, may denote a computer- and/or processor-readable medium that is nontransitory and tangible. By way of example and not limitation, a computer-readable or processor-readable medium may comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer or processor.
Disk and disc, as used herein, includes compact disc (CD), laser disc, optical disc, digital versatile disc (DVD), floppy disk and Blu-ray® disc where disks usually reproduce data magnetically, while discs reproduce data optically with lasers.

It should be noted that one or more of the methods described herein may be implemented in and/or performed using hardware. For example, one or more of the methods described herein may be implemented in and/or realized using a chipset, an application-specific integrated circuit (ASIC), a large-scale integrated circuit (LSI) or integrated circuit, etc.

Each of the methods disclosed herein comprises one or more steps or actions for achieving the described method. The method steps and/or actions may be interchanged with one another and/or combined into a single step without departing from the scope of the claims. In other words, unless a specific order of steps or actions is required for proper operation of the method that is being described, the order and/or use of specific steps and/or actions may be modified without departing from the scope of the claims.

It is to be understood that the claims are not limited to the precise configuration and components illustrated above. Various modifications, changes and variations may be made in the arrangement, operation and details of the systems, methods and apparatus described herein without departing from the scope of the claims.

A program running on the gNB 160 or the UE 102 according to the described systems and methods is a program (a program for causing a computer to operate) that controls a CPU and the like in such a manner as to realize the function according to the described systems and methods. Then, the information that is handled in these apparatuses is temporarily stored in a RAM while being processed. Thereafter, the information is stored in various ROMs or HDDs, and whenever necessary, is read by the CPU to be modified or written. As a recording medium on which the program is stored, among a semiconductor (for example, a ROM, a nonvolatile memory card, and the like), an optical storage medium (for example, a DVD, a MO, a MD, a CD, a BD and the like), a magnetic storage medium (for example, a magnetic tape, a flexible disk and the like) and the like, any one may be possible. Furthermore, in some cases, the function according to the described systems and methods described herein is realized by running the loaded program, and in addition, the function according to the described systems and methods is realized in conjunction with an operating system or other application programs, based on an instruction from the program.

Furthermore, in a case where the programs are available on the market, the program stored on a portable recording medium can be distributed or the program can be transmitted to a server computer that connects through a network such as the Internet. In this case, a storage device in the server computer also is included. Furthermore, some or all of the gNB 160 and the UE 102 according to the systems and methods described herein may be realized as an LSI that is a typical integrated circuit. Each functional block of the gNB 160 and the UE 102 may be individually built into a chip, and some or all functional blocks may be integrated into a chip. Furthermore, a technique of the integrated circuit is not limited to the LSI, and an integrated circuit for the functional block may be realized with a dedicated circuit or a general-purpose processor. Furthermore, if with advances in a semiconductor technology, a technology of an integrated circuit that substitutes for the LSI appears, it is also possible to use an integrated circuit to which the technology applies.

Moreover, each functional block or various features of the base station device and the terminal device used in each of the aforementioned embodiments may be implemented or executed by a circuitry, which is typically an integrated circuit or a plurality of integrated circuits. The circuitry designed to execute the functions described in the present specification may comprise a general-purpose processor, a digital signal processor (DSP), an application specific or general application integrated circuit (ASIC), a field programmable gate array (FPGA), or other programmable logic devices, discrete gates or transistor logic, or a discrete hardware component, or a combination thereof. The general-purpose processor may be a microprocessor, or alternatively, the processor may be a conventional processor, a controller, a microcontroller, or a state machine. The general-purpose processor or each circuit described herein may be configured by a digital circuit or may be configured by an analogue circuit. Further, when a technology of making into an integrated circuit superseding integrated circuits at the present time appears due to advancement of a semiconductor technology, the integrated circuit by this technology is also able to be used.

### CROSS REFERENCE

This Nonprovisional application claims priority under 35 U.S.C. § 119 on provisional Application No. 62/910,152 on Oct. 3, 2019, the entire contents of which are hereby incorporated by reference.

1. A user equipment (UE) comprising:
receiving circuitry configured to receive a radio resource control (RRC) message comprising information used for configuring the UE to monitor a physical downlink control channel (PDCCH) for a downlink control information (DCI) format, the DCI format comprising an interruption transmission indication for uplink, and
processing circuitry configured to cancel a physical uplink shared channel (PUSCH) transmission in a physical resource block(s) and/or a symbol(s) that are indicated by the interruption transmission indication for uplink, wherein
the interruption transmission indication for uplink is applicable to a specific type of uplink transmissions, and
the specific type of uplink transmissions includes a PUSCH and does not include a PRACH.

2. (canceled)

3. A communication method of a user equipment (UE) comprising:
receiving a radio resource control (RRC) message comprising information used for configuring the UE to monitor a physical downlink control channel (PDCCH) for a downlink control information (DCI) format, the DCI format comprising an interruption transmission indication for uplink, and
cancelling a physical uplink shared channel (PUSCH) transmission in a physical resource block(s) and/or a symbol(s) that are indicated by the interruption transmission indication for uplink, wherein
the interruption transmission indication for uplink is applicable to a specific type of uplink transmissions, and
the specific type of uplink transmissions includes a PUSCH and does not include a PRACH.

4. (canceled)
